(19) United States
(12) Patent Application Publication
(10) Pub. No.: US 2019/0297390 A1
(43) Pub. Date: Sep. 26, 2019

(54) METHOD AND SYSTEM FOR PHYSICALLY TAGGING OBJECTS PRIOR TO CREATION OF AN INTERACTIVE VIDEO

(71) Applicant: Brandon Grusd, La Jolla, CA (US)

(72) Inventor: Brandon Grusd, La Jolla, CA (US)

(21) Appl. No.: 16/416,824

(22) Filed: May 20, 2019

Related U.S. Application Data
(63) Continuation-in-part of application No. 15/130,849, filed on Apr. 15, 2016, now Pat. No. 10,299,011.
Application No. 15/130,849 is a continuation of application No. 14/198,519, filed on Mar. 5, 2014, now Pat. No. 9,407,975.
(60) Provisional application No. 61/772,989, filed on Mar. 5, 2013.

(51) Int. Cl. H04N 21/81; H04N 21/858; H04N 21/4725; H04N 21/2668; H04N 21/4722; G06Q 30/02; H04N 21/234; H04N 21/2343; H04N 21/472; H04N 21/478; H04N 21/485; H04N 21/231

(52) U.S. Cl. CPC H04N 21/8173; H04N 21/23109; H04N 21/812; H04N 21/4725; H04N 21/2668; H04N 21/8133; H04N 21/4722; G06Q 30/0241; H04N 21/23418; H04N 21/23439; H04N 21/47202; H04N 21/8586; H04N 21/47815; H04N 21/4858; H04N 21/8583

(57) ABSTRACT

An interactive video including frames which include objects is displayed on a client computing device. A set of the objects in the interactive video have been linked to internet-accessible information external to the video during creation of the interactive video by physically tagging the set of objects, each with a unique tag. The unique tags are then used to associate the objects with information stored in a database, which may include links to internet-accessible information. While the interactive video is playing on the display, a user may select one of the tagged objects. In response to the selection, the associated information is displayed.

### CROSS-REFERENCE TO RELATED APPLICATIONS

This patent application is a continuation-in-part of U.S. patent application Ser. No. 15/130,849, entitled “METHOD AND SYSTEM FOR USER INTERACTION WITH OBJECTS IN A VIDEO LINKED TO INTERNET-ACCESSIBLE INFORMATION ABOUT THE OBJECTS,” filed on Apr. 15, 2016, which is a continuation of U.S. patent application Ser. No. 14/198,519, entitled “SYSTEMS AND METHODS FOR PROVIDING USER INTERACTIONS WITH MEDIA,” filed on Mar. 5, 2014, which claims priority to U.S. provisional patent application 61/772,989, filed on Mar. 5, 2013, both of which are incorporated by reference along with all other references cited in this application.

### BACKGROUND OF THE INVENTION

Traditional viewing of video is burdened by its inherently passive experience. Regardless of the device (TV, Movie Screen, Mobile Device, Computer, Tablet computer, etc.)

Currently, there is no system or method that identifies, encodes, and tracks visual objects in video and allow viewers to interact with those objects, whether by clicking, touching, pointing, waving or a similar interaction method, hereinafter referred to as “clicking”) in order to: (i) discover the identity and related metadata of said object, (ii) be provided with an opportunity to purchase that object, (iii) be served an advertisement directly based on the identity of said object, and/or be offered (iv) a richer content experience based on the identity of said object.

### SUMMARY OF THE INVENTION

Various systems and methods are disclosed in which one or more objects in a video stream may be identified throughout the video stream and linked to any of (a) ecommerce sites, links or experiences for immediate purchase, (b) advertisements based on the identity and nature of said object(s), and/or (c) richer content experiences based on the identity and/or nature of said object(s). A user may click on an object in a video, have that object be identified, and/or be provided with a link or set of information about the object. The user may be able to immediately purchase that object online. An advertisement or additional content experience may be displayed to a user based on the object.

A video stream may be encoded with a separate metadata stream that contains the identity of each object on each frame of the video. The metadata relating to any object within the video stream may be extracted from the video stream and displayed to a user when the user clicks on the corresponding object.

Disclosed are systems and methods for tagging objects in video, identifying objects manually, semi-autonomously, and autonomously using various computer vision and machine learning algorithms, identifying and/or tracking those objects in video, and linking those objects to, any of (a) destinations or other opportunities to purchase those or related objects, (b) advertisements based on the nature of said object. In some implementations, tagging includes drawing a region of interest (ROI) around an object of interest, automatically tracking said object across the video using one or more computer vision algorithms when tracking gets lost then searching the frame for the object and comparing search results to a database of objects to re-identify the object and continue to track it. Object recognition may include comparing an ROI to a database of predetermined and identified items, as well as negative examples. Objects that are deemed by a computer vision algorithm to be the same or similar enough to an object in the database will be labeled as such object. A user will be able to edit incorrectly labeled objects, and the database will be updated. In various implementations, various frame segmentation algorithms are used, where each frame will be segmented autonomously. Each object segmented within the frame will be automatically compared to a database of pre-identified objects. The same or similar objects will be labeled as such object. A user will be able to edit incorrectly labeled objects, and the database will be updated.

In some implementations, a method is disclosed, the method comprising allowing a user to click on an object in a video, have that object be identified and provide the user with a link or set of information about said tagged object. Identification may involve searching a particular video and frame of a previously tagged video and recalling the previously identified reference to an objects database. Identification may also involve automatically segmenting a frame, and determining the outline of the object of interest, then comparing said object to a database of all objects.

In various implementations, a method is disclosed, the method comprising allowing a user to click on an object in a video, have that object be identified and provide the user with the ability to immediately purchase that object online. Identification may involve searching a particular video and frame of a previously tagged video and recalling a previously identified reference to an objects database. Identification may also involve automatically segmenting a frame, and determining the outline of the object of interest, then comparing said object to a database of all objects.

According to some implementations, a method is disclosed, the method comprising allowing a user to click on an object in a video, and have an advertisement based on said object be displayed for that user. Identification may involve searching a particular video and frame of a previously tagged video and recalling the previously identified reference to an objects database. Identification may also involve automatically segmenting a frame, and determining the outline of the object of interest, then comparing said object to a database of all objects. Various factors analyzed may include: how much of the screen does the tagged object take up; how many frames does the particular object appear in; a location of a tagged object on screen (foreground weighted more than background, center objects are weighted more); a real life cost of the object; what objects are clicked upon (more clicks equals more popular and more ads based on those objects); an auction model where people pay for objects; a color of an object; a theme of a video scene (drama, comedy, reality, home improvement, sports, cooking, news, horror, romance, etc.); demographics of a person watching a video, as well as demographics of video as a whole; a particular device a video is being displayed upon; prior purchase and click history of particular user and users as a whole; a popularity of a particular object based on total sales (number of units and dollar amount); and an identity and popularity of a person (actor or actress) in a video associated with an object.

In some implementations, a method is disclosed, the method comprising encoding a pre-existing video stream with a separate metadata stream that contains the identity of each object on each frame of the video.

In various implementations, a method is disclosed, the method comprising extracting a metadata channel from a video stream and displaying said data to a user when the user clicks on the corresponding object or otherwise.

According to some implementations, an apparatus is disclosed, the apparatus comprising a device or devices that take a video input, analyze said input, and recognize the video (name of video, name of episode, etc.). The device or devices may look up said video in a database of tagged videos, and output as an overlay or separate window to a video display device stream with information about the item (name, brand, internet or brick & mortar locations to purchase, list of similar products or other recommended products, advertisements, color, web search information, Wikipedia entry, sport statistics etc.).

In various implementations, an apparatus is disclosed, the apparatus comprising a user interface device that allows a user to point to and select an object on a video screen and select and choose said object for integration with the previously described device or devices.

In some implementations, a method is disclosed, the method comprising displaying an advertisement based on the types of objects present within the video. The displaying may be based on one or more of the following: how much of the screen does the tagged object take up; how many frames does the particular object appear in; a location of a tagged object on screen (foreground weighted more than background, center objects are weighted more); a real life cost of the object; what objects are clicked upon (more clicks equals more popular and more ads based on those objects); an auction model where people pay for objects; a color of an object; a theme of a video/scene (drama, comedy, reality, home improvement, sports, cooking, news, horror, romance, etc.); demographics of a person watching video, as well as demographics of video as a whole; a particular device a video is being displayed upon; prior purchase and click history of particular user and users as a whole; a popularity of particular object based on total sales (number of units and dollar amount); and an identity and popularity of a person (actor or actress) in a video associated with an object.

In particular implementations, a method is disclosed, the method comprising providing scene sentiment detection and categorization.

### BRIEF DESCRIPTION OF THE DRAWINGS

FIG. 1 shows a block diagram of a client-server system and network, according to some implementations.

FIG. 2 shows a more detailed diagram of an exemplary client or computer, according to some implementations.

FIG. 3 shows a system block diagram of a client computer system, according to some implementations.

FIG. 4 shows an example of a diagram of one or more components of a system, according to some implementations.

FIG. 5 shows an example of a block diagram of one or more processes, according to some implementations.

FIG. 6 shows another example of a block diagram of one or more processes, according to some implementations.

FIG. 7 shows another example of a block diagram of one or more processes, according to some implementations.

FIG. 8 shows another example of a diagram of one or more components of a system, according to some implementations.

FIG. 9 shows another example of a diagram of one or more components of a system, according to some implementations.

FIG. 10 shows another example of a diagram of one or more components of a system, according to some implementations.

FIG. 11 shows another example of a diagram of one or more components of a system, according to some implementations.

FIG. 12 shows an example of a block diagram of one or more processes, according to some implementations.

FIG. 13 shows another example of a diagram of one or more components of a system, according to some implementations.

FIG. 14 shows another example of a diagram of one or more components of a system, according to some implementations.

FIG. 15 shows another example of a diagram of one or more components of a system, according to some implementations.

FIG. 16 shows another example of a diagram of one or more components of a system, according to some implementations.

FIG. 17 shows another example of a diagram of one or more components of a system, according to some implementations.

FIG. 18 shows another example of a diagram of one or more components of a system, according to some implementations.

FIG. 19 shows aspects of a number of embodiments of a system for tagging items in a video.

FIG. 20 shows a block diagram of an embodiment of a method for tagging items in a video.

FIG. 21 shows aspects of an embodiment of a system for tagging items in a video.

FIG. 22 shows an example of pre-identified objects that may act as a physical tag in an embodiment.

FIG. 23 shows an example of pre-identified objects that may act as a physical tag in an embodiment.

FIG. 24 shows an example of facial features that may act as a physical tag in an embodiment.

FIG. 25 shows examples of items with features that may be used as a pre-identified tag.

FIG. 26 shows examples of objects with features that may be used as a pre-identified tag.

FIG. 27 shows examples of tags that may be applied to object and used as a pre-identified tag during video acquisition.

### DETAILED DESCRIPTION OF THE INVENTION

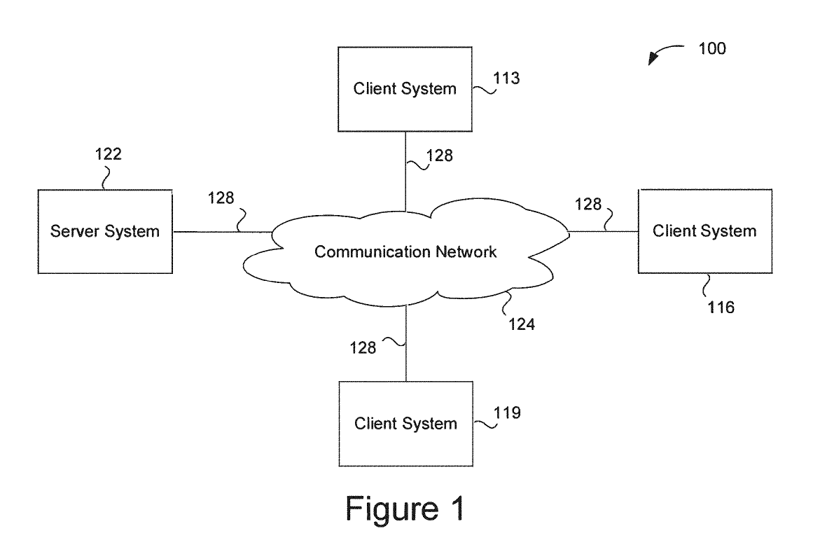

FIG. 1 is a simplified block diagram of a distributed computer network 100. Computer network 100 includes a number of client systems 113, 116, and 119, and a server system 122 coupled to a communication network 124 via a plurality of communication links 128. There may be any number of clients and servers in a system. Communication network 124 provides a mechanism for allowing the various components of distributed network 100 to communicate and exchange information with each other.

Communication network 124 may itself be comprised of many interconnected computer systems and communication links. Communication links 128 may be hardwire links, optical links, satellite or other wireless communications links, wave propagation links, or any other mechanisms for communication of information. Various communication protocols may be used to facilitate communication between the various systems shown in FIG. 1. These communication protocols may include TCP/IP, HTTP protocols, wireless application protocol (WAP), vendor-specific protocols, customized protocols, and others. While in one embodiment, communication network 124 is the Internet, in other embodiments, communication network 124 may be any suitable communication network including a local area network (LAN), a wide area network (WAN), a wireless network, a intranet, a private network, a public network, a switched network, and combinations of these, and the like.

Distributed computer network 100 in FIG. 1 is merely illustrative of an embodiment and is not intended to limit the scope of the invention as recited in the claims. One of ordinary skill in the art would recognize other variations, modifications, and alternatives. For example, more than one server system 122 may be connected to communication network 124. As another example, a number of client systems 113, 116, and 119 may be coupled to communication network 124 via an access provider (not shown) or via some other server system.

Client systems 113, 116, and 119 typically request information from a server system which provides the information. For this reason, server systems typically have more computing and storage capacity than client systems. However, a particular computer system may act as both a client or a server depending on whether the computer system is requesting or providing information. Additionally, although aspects of the invention have been described using a client-server environment, it should be apparent that the invention may also be embodied in a stand-alone computer system. Aspects of the invention may be embodied using a client-server environment or a cloud-computing environment.

Server 122 is responsible for receiving information requests from client systems 113, 116, and 119, performing processing required to satisfy the requests, and for forwarding the results corresponding to the requests back to the requesting client system. The processing required to satisfy the request may be performed by server system 122 or may alternatively be delegated to other servers connected to communication network 124.

Client systems 113, 116, and 119 enable users to access and query information stored by server system 122. In a specific embodiment, a “Web browser” application executing on a client system enables users to select, access, retrieve, or query information stored by server system 122. Examples of web browsers include the Internet Explorer browser program provided by Microsoft Corporation, the Firefox browser provided by Mozilla Foundation, the Chrome browser provided by Google, the Safari browser provided by Apple, and others.

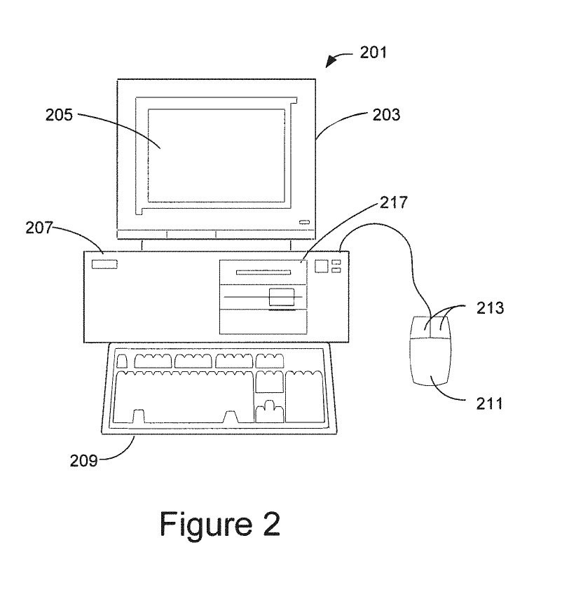

FIG. 2 shows an exemplary client or server system. In an embodiment, a user interfaces with the system through a computer workstation system, such as shown in FIG. 2. FIG. 2 shows a computer system 201 that includes a monitor 203, screen 205, cabinet 207, keyboard 209, and mouse 211. Mouse 211 may have one or more buttons such as mouse buttons 213. Cabinet 207 houses familiar computer components, some of which are not shown, such as a processor, memory, mass storage devices 217, and the like.

Mass storage devices 217 may include mass disk drives, floppy disks, magnetic disks, optical disks, magneto-optical disks, fixed disks, hard disks, CD-ROMs, recordable CDs, DVDs, recordable DVDs (e.g., DVD-R, DVD+R, DVD-RW, DVD+RW, HD-DVD, or Blu-ray Disc), flash and other nonvolatile solid-state storage (e.g., USB flash drive), battery-backed-up volatile memory, tape storage, reader, and other similar media, and combinations of these.

A computer-implemented or computer-executable version of the invention may be embodied using, stored on, or associated with computer-readable medium or non-transitory computer-readable medium. A computer-readable medium may include any medium that participates in providing instructions to one or more processors for execution. Such a medium may take many forms including, but not limited to, nonvolatile, volatile, and transmission media. Nonvolatile media includes, for example, flash memory, or optical or magnetic disks. Volatile media includes static or dynamic memory, such as cache memory or RAM. Transmission media includes coaxial cables, copper wire, fiber optic lines, and wires arranged in a bus. Transmission media can also take the form of electromagnetic, radio frequency, acoustic, or light waves, such as those generated during radio wave and infrared data communications.

For example, a binary, machine-executable version, of the software of the present invention may be stored or reside in RAM or cache memory, or on mass storage device 217. The source code of the software may also be stored or reside on mass storage device 217 (e.g., hard disk, magnetic disk, tape, or CD-ROM). As a further example, code may be transmitted via wires, radio waves, or through a network such as the Internet.

While FIG. 2 depicts a computer system 201 that includes a monitor 203, screen 205, cabinet 207, keyboard 209, and mouse 211, it will be appreciated that various implementations may utilize a mobile device, such as a Smartphone, a tablet PC, or any other device capable of mobile computing.

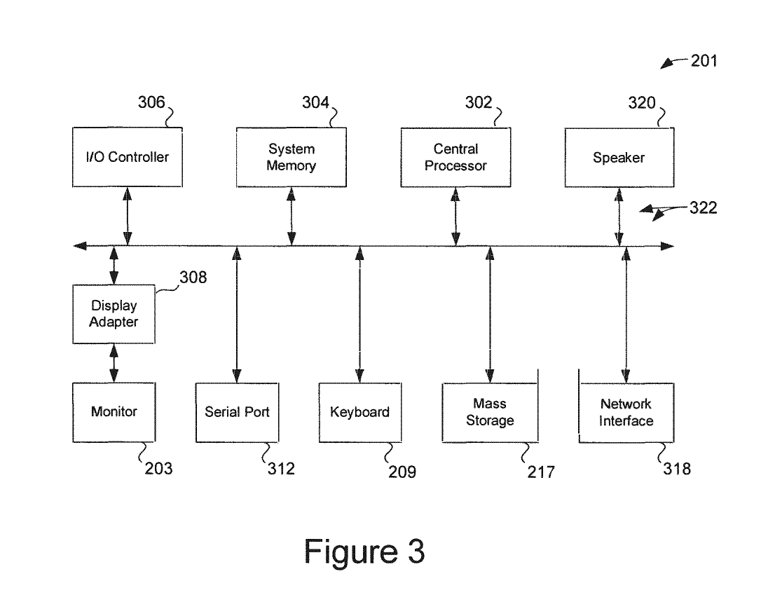

FIG. 3 shows a system block diagram of computer system 201. As in FIG. 2, computer system 201 may include a monitor 203, keyboard 209, and mass storage devices 217. Computer system 201 further includes subsystems such as central processor 302, system memory 304, input/output (I/O) controller 306, display adapter 308, serial or universal serial bus (USB) port 312, network interface 318, and speaker 320. In an embodiment, a computer system includes additional or fewer subsystems. For example, a computer system could include more than one processor 302 (i.e., a multiprocessor system) or a system may include a cache memory.

Arrows such as 322 represent the system bus architecture of computer system 201. However, these arrows are illustrative of any interconnection scheme serving to link the subsystems. For example, speaker 320 could be connected to the other subsystems through a port or have an internal direct connection to central processor 302. The processor may include multiple processors or a multicore processor, which may permit parallel processing of information. Computer system 201 shown in FIG. 2 is but an example of a suitable computer system. Other configurations of subsystems suitable for use will be readily apparent to one of ordinary skill in the art.

Computer software products may be written in any of various suitable programming languages, such as C, C++, C#, Pascal, Fortran, Perl, Matlab (from MathWorks), SAS, SPSS, JavaScript, AJAX, Java, SQL, and XQuery (a query language that is designed to process data from XML files or any data source that can be viewed as XML, HTML, or both). The computer software product may be an independent application with data input and data display modules. Alternatively, the computer software products may be classes that may be instantiated as distributed objects. The computer software products may also be component software such as Java Beans (from Oracle Corporation) or Enterprise Java Beans (EJB from Oracle Corporation). In a specific embodiment, the present invention provides a computer program product which stores instructions such as computer code to program a computer to perform any of the processes or techniques described.

An operating system for the system may be one of the Microsoft Windows® family of operating systems (e.g., Windows 95, 98, Me, Windows NT, Windows 2000, Windows XP, Windows XP x64 Edition, Windows Vista, Windows 7, Windows CE, Windows Mobile), Linux, HP-UX, UNIX, Sun OS, Solaris, Mac OS X, Alpha OS, AIX, IRIX32, IRIX64, iOS provided by Apple, Android provided by Google. Other operating systems may be used. Microsoft Windows is a trademark of Microsoft Corporation.

Furthermore, the computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of the system using a wireless network using a protocol such as Wi-Fi (IEEE standards 802.11, 802.11a, 802.11b, 802.11e, 802.11g, 802.11i, and 802.11n, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

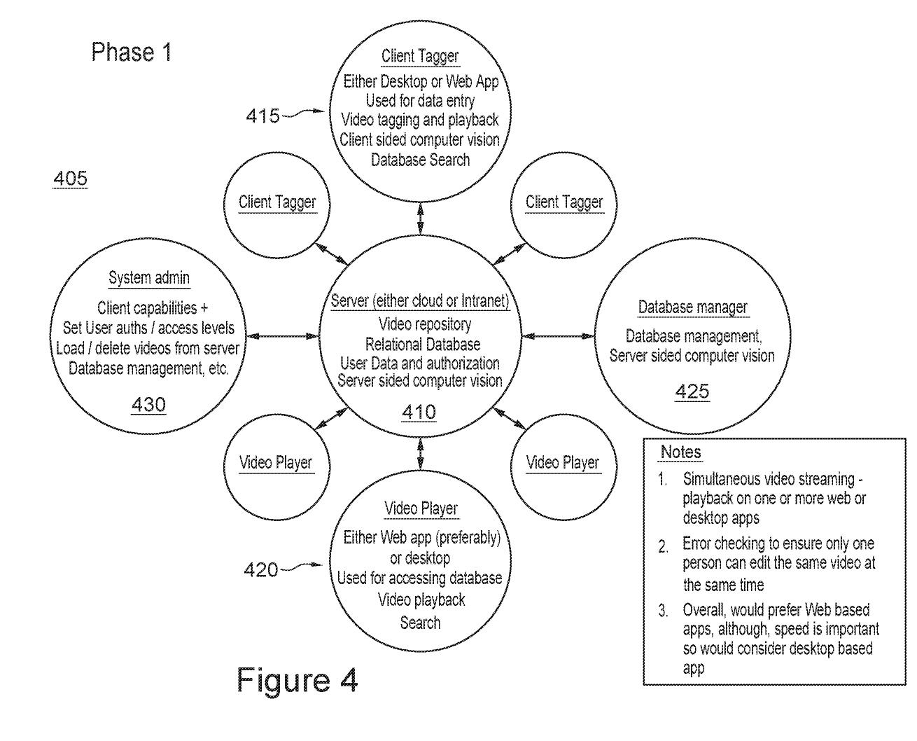

With reference to FIGS. 4-18, according to some implementations, an integrated system is provided that may, among other things, enable the tagging of videos. For example, visual objects in a video may be automatically tagged using computer vision and machine learning algorithms. In some implementations, each tagged item is linked to an online ecommerce site, brick and mortar store, comparative shopping site, or search result from a search engine. Each tagged item may also be linked to an advertisement based on the particular identification of the item being tagged. The tagging process may include taking a video and dividing each video into shots (where a shot is a series of interrelated consecutive pictures taken contiguously by a single camera and representing a continuous action in time and space). The series of shots may be rearranged such that similar shots are combined to form a supershot. Each face from the video may be automatically extracted, and similar faces may be sorted and binned together for identification by machine learning algorithms with human supervision. Accordingly, each face within a video may be labeled with the actor's real name and character name.

FIG. 4 shows a simplified block diagram of some components of system 405. The system supports simultaneous video streaming and playback on web, mobile, or desktop applications. Error checking is provided to help ensure that only one person can edit the same video at the same time. This system includes a server system 410, client taggers 415, video players 420, a database manager 425, and a system administration module 430.

The server system includes storage for a video repository and user data. The data can be stored in a relational database. The server system is responsible for user data and authorization and server-sided computer vision processing.

The client tagger can be a desktop, mobile, or web application. The tagger is used for data entry including video tagging and playback. The tagger provides an interface for database searches and is responsible for client-sided computer vision processing.

The video player can be a web, mobile, or desktop application. The player is responsible for video playback. The player includes an interface for searching. The database can be accessed through the player. The database manager is responsible for database management and facilitates the server-sided computer vision processing.

The system administration module is responsible for setting the client capabilities including, for example, setting user authorization and access levels, loading and deleting videos from the server, database management, and other administration tasks.

In various implementations, tagging includes drawing an ROI around an object of interest, and automatically tracking said object across the supershot using computer vision algorithms with or without human supervision. Each object may be labeled and various data may be stored, including but not limited to, the SKU number, color or colors, name of the item, brand of the item, location within the frame, the time stamp or frame number within the video when the object is visible, the name, genre, date of publication, and type of video in which the object appears). According to some implementations, if the tracking gets lost, the tagging system may search each pixel or series of pixels of each frame of the video or supershot for the item. Each of the pixels or series of pixels will be compared to a database of objects in order to re-identify the object being tracked and thereby continue to track it. In some implementations, object recognition may include comparing an ROI to a database of predetermined and identified items, as well as negative examples. Objects that are deemed by computer vision algorithms to be the same or similar enough to an object in the database may be labeled as such object. A user may be able to edit incorrectly labeled objects, and the database may be updated.

In various implementations, this process may be repeated until all items within a video are labeled, identified, and linked. Once a sufficiently robust and large database of objects is created, the process can be run autonomously without human interaction.

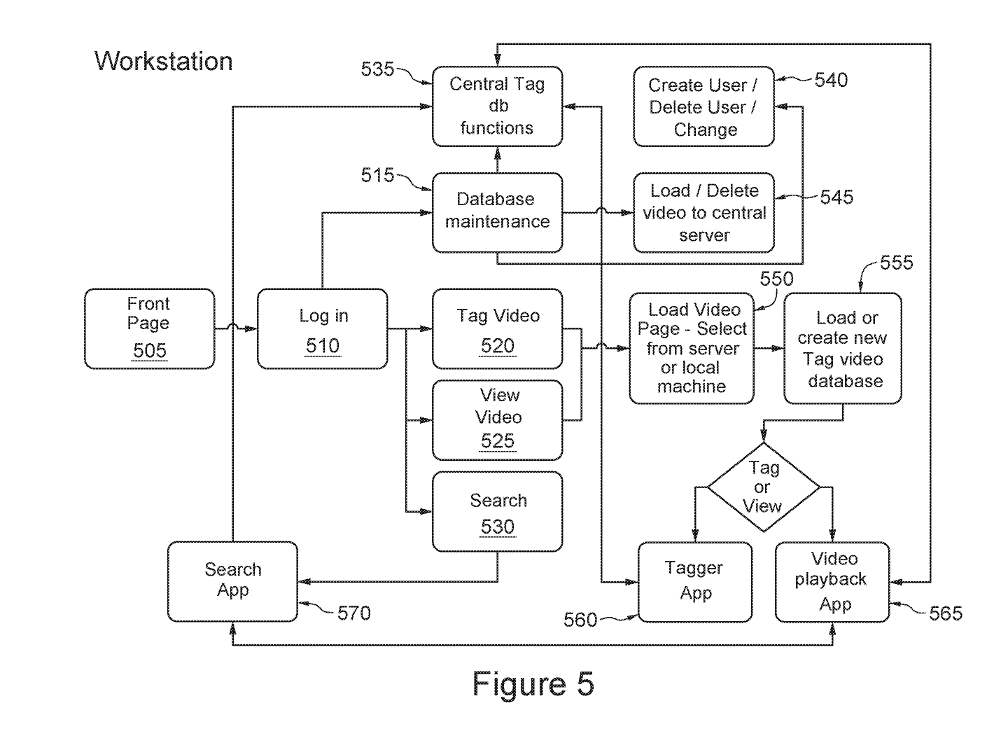

FIG. 5 shows a block diagram of some tagging components. In a specific embodiment, from a front page 505 of the system, a user can log in 510. After logging in, the system presents the user with options for accessing modules including database maintenance 515, video tagging 520, video viewing 525, or video searching 530. The database maintenance module includes a central tag database 535, a module 540 for creating a user, deleting a user, and a module 545 for loading a video to the central server or deleting a video from the central server.

The video tagging and view modules provide functions for loading a video 550 and loading or creating a new tag video database 555. Selecting the tagging option launches a tagger app 560. Selecting the viewing option launches a video playback app 565. Selecting the search option launches a search app 570.

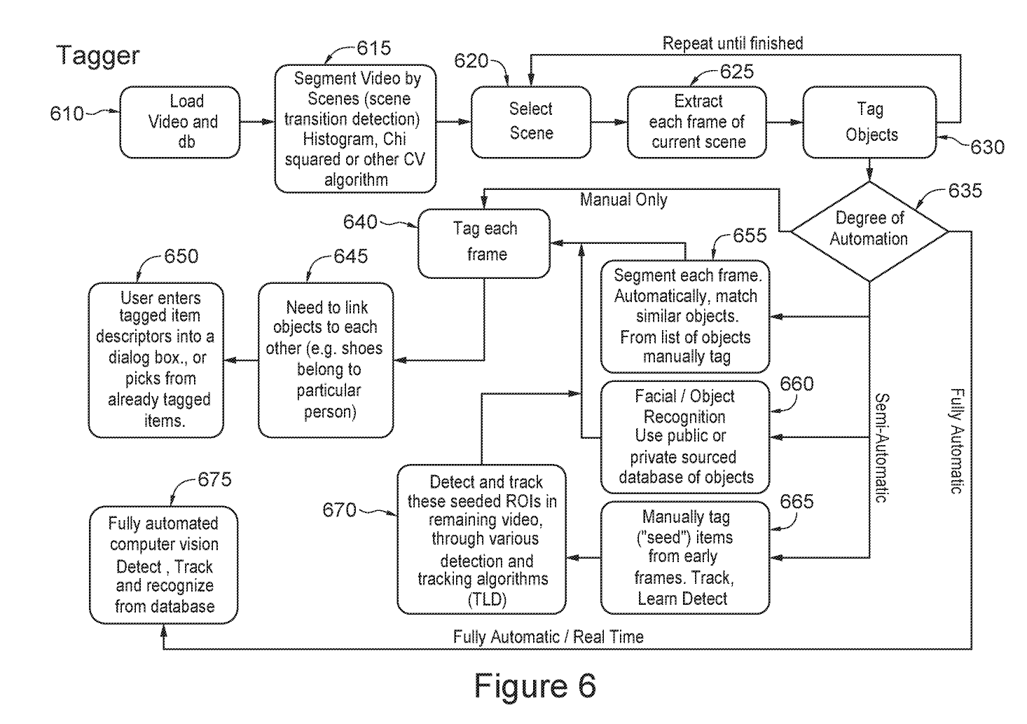

FIG. 6 shows a flow diagram for tagging. In a specific implementation, a step 610 includes loading a video and database. A step 615 includes segmenting a video scene by scene. The segmentation can include techniques involving scene transition detection, histograms, Chi squared, or other computer vision techniques. A step 620 includes selecting a scene. A step 625 includes extracting each frame of a current scene. A step 630 includes tagging objects in a frame.

Various implementations of the tagging process involve varying degrees of automation 635. In a specific implementation, tagging each frame 640 is a manual process. The tagging includes linking objects to each other (e.g., associating shoes as belonging to a particular person) 645. In a step 650, a user enters tagged item descriptors into a dialog box. Alternatively, the user can pick from already tagged items.

In another specific implementation, tagging is a semi-automatic process. In this specific implementation, the tagging includes a step 655 for segmenting each frame. The system automatically matches similar objects from a list of objects manually tagged. In a step 660, the system includes facial and object recognition. The recognition can rely on a publically sourced database of objects, a privately sourced database of objects, or both. A step 665 includes manually tagging (“seeding”) items from early frames and tracking, learning, and detecting. A step 670 includes detecting and tracking these seeded ROIs in the remaining videos through various detection and tracking algorithms.

In another specific implementation, tagging is fully automatic 675. In this specific implementation, the system provides for fully automated computer vision for detecting, tracking, and recognizing from a database.

Once a video has been tagged, a user may be able to click, point, touch or otherwise connect to the object with any user interface options, and have the various data and URL links displayed. Thus the user may instantly purchase the item, save item to be purchased later, or share the item. The user may also have each click be stored in a personal database for that user such that the user can later on search, list, share or otherwise display the items upon which he or she clicked. The user may also search the database of tagged objects.

For those video display devices that do not have a built in ability to click, touch, point, select though speech recognition, or otherwise select an object on the screen, a separate user interface device may be provided. In various implementations, the device: takes the video stream from a cable, satellite or other video provider, as an input; compares the video stream to the database of tagged objects to identify the video; connects to a wireless pointing device that enables a user to point at a video screen and select an object being displayed; and as an output displays the appropriate URL links, advertisements, and other data relevant to the item selected. Thus, the device allows the user to instantly purchase the item, save the item to be purchased later, share the object with a friend over various social networking sites, email, text messaging, etc., and store the selection for later display, search, listing, or sharing.

Additionally, each object tagged within the video may have a corresponding advertisement that will be displayed either as an overlay on the video or along the gutter of the screen. Each advertisement may be linked to the website or other URL directed by the advertiser.

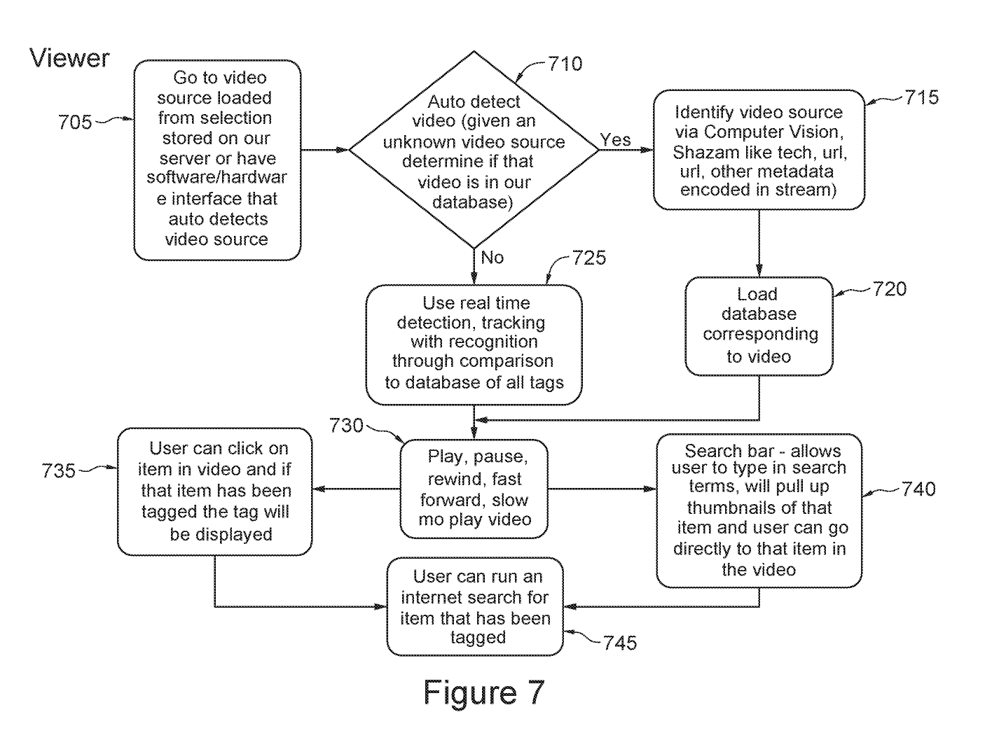

FIG. 7 shows a flow diagram for a viewer of the system. A step 705 includes accessing a video source. In a specific implementation, a video can be loaded from a repository of the system. In another specific implementation, there is a software/hardware interface that automatically detects a video source. In a step 710, autodetection includes given an unknown video source, determining if the video is in a database of the system. If so, a step 715 includes identifying a video source via, for example, computer vision, Shazam, a URL, or other metadata encoded in a stream. A step 720 includes loading from a database corresponding to the video. If not, a step 725 includes real-time detection and tracking with recognition through a comparison to the database of all tags.

The viewer includes controls 730 for play, pause, rewind, fast forward, and slow motion playing of the video. A user can click 735 on an item in a video. If that item has been tagged, the tag will be displayed. Alternatively, the viewer may include a search bar 740 that allows the user to type in search terms. The search tool may return a set of thumbnails associated with the item and the user can access the item directly. The user can then run 745 an Internet search for the item that has been tagged.

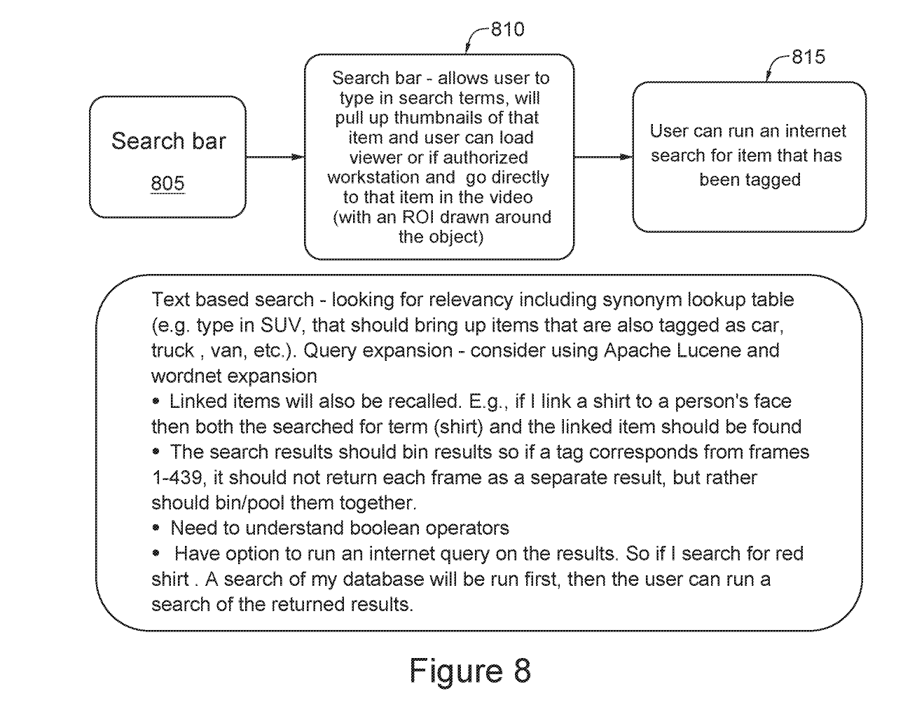

FIG. 8 shows a more detailed flow of search bar searching 805. The search bar allows the user to type in search terms. A search result may include thumbnails of that item. The user can load a viewer or if the user is on an authorized workstation, go directly to that item in the video where there will be an ROI drawn around the object (step 810). In a step 815, the user can run an Internet search for the item that has been tagged.

There can be a text based search. A text based search includes looking or analyzing for relevancy. There can be a synonym lookup table. For example, inputting “SUV” may return items that are tagged as “car,” “truck,” “van,” and so forth. There can be query expansion using Apache Lucene and wordnet expansion.

In a specific implementation, linked items will also be recalled. For example, if there is a link of a shirt to a person's face the both the searched for term (e.g., search) and linked item may be found.

In a specific implementation, search results include bin results. For example, if a tag corresponds from frames 1-439, the system may not return each frame as a separate result, but may bin or pool them together. There can be logic for understanding Boolean operators. There can be an option to run an internet query on the results. Consider, as an example, a search for red shirt. A search of the system database may be run first. The user can then run a search of the returned results.

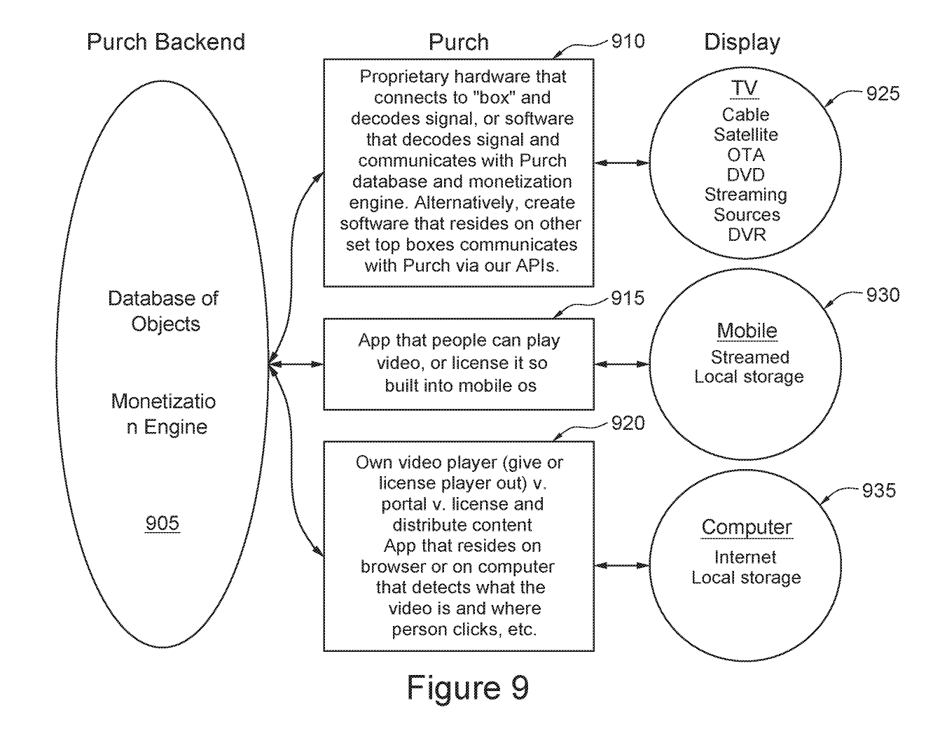

FIG. 9 shows a block diagram of an overall architecture of the system. In a specific embodiment, the system includes a database of objects and a monetization engine 905 which may be connected to proprietary hardware 910, an application 915, or a video player 920. Proprietary hardware may include hardware that connects to a “box” and that decodes a signal, or software that decodes a single and communicates with the system database and monetization engine. Alternatively, there can be software that resides on set top boxes and communicates with the system through APIs. The proprietary hardware may be connected to a TV display device 925.

Application 915 includes an app so that people can play video. There can be a license in which the app is built into a mobile operating system. The application may be connected to a mobile display device 930. The video player may be provided without charge or licensed. There can be a portal. Content may be distributed from the system. There can be an application that resides on the browser or computer that detects the video and tracks user activity such as where the person clicks. The application may be connected to a computer display device 935.

Moreover, with regards to FIGS. 4-9, in various implementations, a database of username and access levels may be included. The database of username and access levels may store information identifying one or more of: a username; a password; an email address; an access level; a system admin; and a tagger.

According to various implementations, various determinations are made regarding front-end viewers. For example, ROIs clicked on by users may be determined. Search terms used by users may be determined. Market intelligence may be applied based on these determinations.

In some implementations, auto-tagging is run using detection algorithms that may make comparisons with a database of all tags. The algorithms may determine how well auto tagging worked, and the ROC (Receiver Operator Characteristics) of the autodetection. In various implementation, the algorithms may be run against all objects or be used to auto-tag particular objects. The ROIs may be converted to appropriate data for use in recognition depending on the detection algorithm used (Hessian matrix, histogram, eigenvalues, etc.). SKU numbers may be added if not initially tagged to those items with generic tags. In some implementations, other source data manipulation and analysis may be performed. For example, links between items such as foreground and background may be determined based on whether or not ROIs are totally within other ROIs. In this example, foreground objects in general would either be totally encapsulated by background objects or be taller than background objects. In another example, analytical methods may be applied to evaluate whether or not auto linkages can be made between tagged or auto-tagged items (e.g. a tagged shirt under a tagged head should be linked together). Eventually, other data may be incorporated into each tagged video. For example, a transcript of audio or an identity of music that is played may be included.

In various implementations, various features associated with a keyboard, such as keyboard shortcuts are provided to facilitate the tagging process. The keyboard shortcuts may be user editable. Some default keyboard shortcuts may be: L=link; U=unlink; P=Person/face category; A=Automobiles of any sort category; C=Clothing/shoes/etc. category; E=Electronics category; J=Jewelry category; F=Food; and D=Furniture.

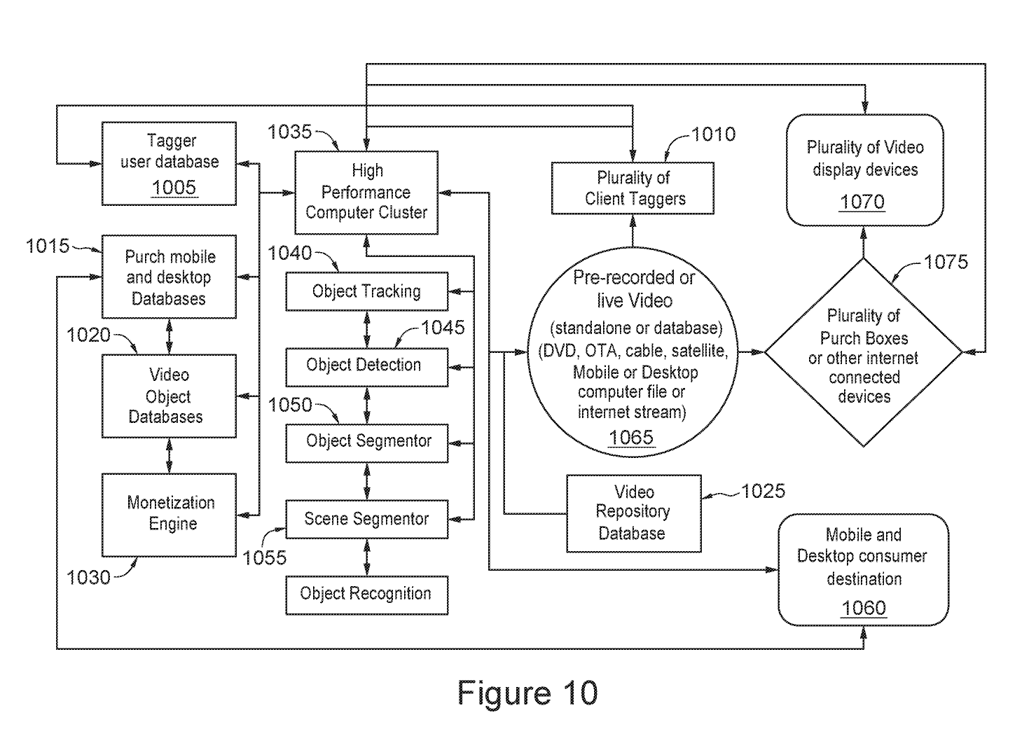

Furthermore, with regards to FIG. 10, additional details and implementations of a tagging system are described. In various implementations, a tagger user database 1005 may be included. The tagger user database may include one or more identifiers that identify authorized users who can access the tagger client application 1010. The database may store a unique tagger identifier, a self chosen username, a user email, a user password, and a user authorization level.

In some implementations, mobile and desktop databases 1015 may be included. The mobile and desktop databases may include a series of interconnected databases that stores consumer users' information. The information may include: a user name; a user id; a password; credit card information; an email address; a real address and phone number; a list of past purchases and date of those purchases; a list of past items clicked upon but not purchased and date; a list of items added to shopping cart but not purchased; a list of users' friends; a list of search queries; a list of favorited items, television shows, characters; and user comments for items, television shows, characters, or other various media.

According to various implementations, a video object database 1020 may be included. The video object database may include a series of databases that stores a list of all the objects tagged in videos. In some implementations, the list may contain: the video name where the object was tagged; the name and other object descriptors; the color(s) of the object; an array of other objects that the current object is linked to (e.g., if the current object is a shirt this may be linked to the face of the actor wearing the shirt); a SKU of the object; frame number(s) or timestamp(s) when the object is visible; the location in each particular frame where the object is visible; and x,y coordinates as well as a size of an associated ROI.

In particular implementations, a video repository database 1025 may be included. The video repository database may include a list of all the videos in the repository. In some implementations, the list may include: a name of a video; a series number; an episode name; an episode number; a year a video was published; a network a video was first displayed on; a type of video (TV, movie, commercial, advertisement, education, etc.); a category of a video (sitcom, drama, action, etc.); a location of the video (e.g. where it is stored on a file server); whether or not the video is currently being tagged (checked by username); whether the video was a live video stream that was auto-tagged; a percent of video tagged (number of frames tagged/total number of frames*100%); a percent of actual product names tagged (% SKU'd=total number of tags with SKU assigned v. total number of tags); and who a video was checked out by, as identified by their username.

In some implementations, a monetization engine 1030 may be included. A monetization engine may be a combination of data mining and secondary databases that link the following metrics to advertisement, products, retailers, or other information to a particular video: a theme of a video; a sentiment of particular scene; an object's visibility in frame; a location of an object in frame; the area the particular objects take up in the frame; a percent of time a particular object is in a scene/video; a linkage of objects to actors, people, or other objects; a popularity of an actor; a perception of a character's role in particular video; a color of an object; a real life valuation of object; a consumer demographic; past purchasing and click behavior; friends' past behavior; a frequency with which an object appears in video or other videos; past browsing, searching, liking, listing history of a particular user on Purch application or website; a past history of the other users who have looked, purchased, liked the same product, actor, actress, or video, etc.

In various implementations, a price/value may be assigned to each object within a video based on the previously described data. Additionally, this data is used as a starting point for keyword bidding advertisers, retailers, and other third party vendors to bid on objects in an auction, such that the highest bidder's ad, product, link, etc. will be displayed when the user clicks on that object while watching a video.

According to various implementations, a high performance computing cluster (HPCC) 1035 may be included. The high performance computing cluster may be an enterprise and/or cloud based CPU/GPU solution that links the various components of the system together. Thus, the high performance computing cluster may provide communications to and from the video repository, and may further provide database server administration, desktop and mobile site administration, ecommerce and advertising solutions. The high performance computing cluster may also be used to run the tagger, object recognition, and other various computer vision software. It will be appreciated that running these features is not limited to the cloud or enterprise high performance computing cluster. These features may be run on a standalone computing device including but not limited to a desktop computer, tablet computer, workstation, Smartphone etc.

In some implementations, an implementation of computer vision may be included. The computer vision may include object tracking 1040, detection, recognition 1045, segmentation 1050, and scene segmentation 1055.

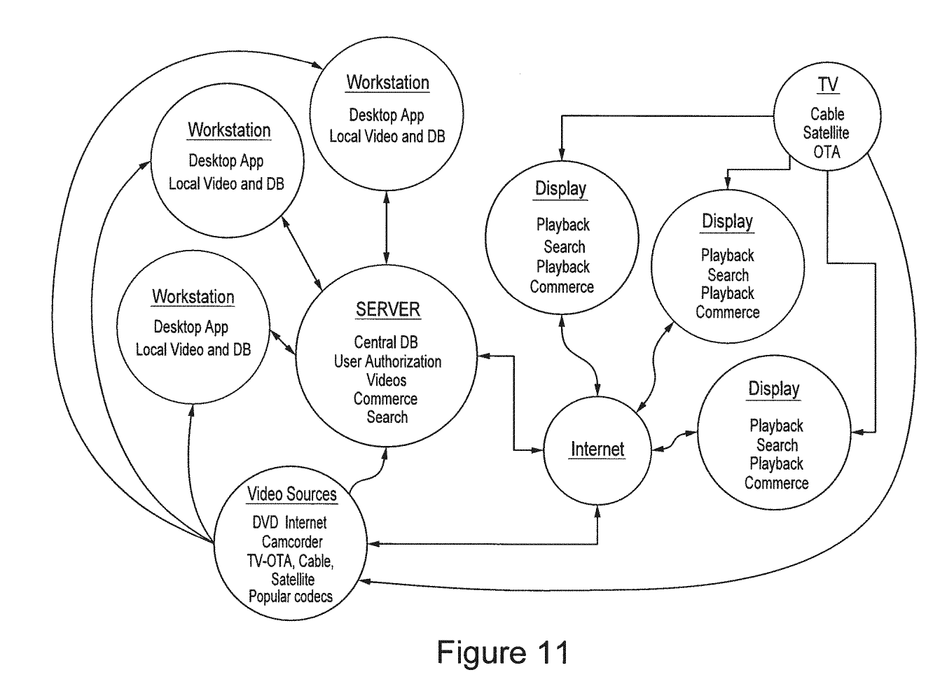

In various implementations, a client tagger may be included. As discussed in greater detail with reference to FIGS. 11-15, the client tagger may be a software program run either on the cloud, enterprise server, HPCC, standalone computing device, or some combination thereof. The client tagger may enable a user to semi-automatically tag one or more objects within a video, frame by frame.

According to various implementations, a mobile and desktop consumer destination 1060 may be included. The mobile and desktop consumer destination may be a website or application that enables users to: log in and sign up with username and password, or through linkages with other social networking sites, including but not limited to Facebook, Twitter, Google+, etc.; and search for objects that they have seen in video. In various implementations, search queries can be generic or specific. For example, queries for a red shirt may be increasingly specific such as “shirt->red shirt->red shirt on Big Bang Theory->red shirt on Big Bang Theory worn by Sheldon”. In some implementations, depending on the query, results will display a thumbnail picture of the object or objects found, the name of the video where the object was located, a text description about the object, links to other websites containing information about the object, a list of similar objects the user may be interested in, links to various vendors that sell the object, advertisements based on the particular search terms, user comments about the object, and other videos where similar items have appeared.

In some implementations, the mobile and desktop consumer destination may also allow one or more users to: browse a list of objects tagged in particular videos (for example, a user may pick a particular movie or television show including a particular episode and see all the objects in that video); browse by particular actor or character; browse by video genre, where each item browsed will be represented by a picture, a text description about the object, similar objects the user may be interested in, links to various vendors that sell the object, advertisements based on the particular video being browsed, or based on the particular item selected, user generated comments about the particular item; purchase objects of interest; like or dislike objects, videos, actors or actresses that the user finds on the Purch destination; enter user generated comments about particular items; create lists of objects that are of interest to the user; browse lists of objects created by other users of Purch or members of their social network; share or recommend objects or lists with other users of Purch or with members of their social network; and take a picture of an item one sees in real-life and see if that item or similar items is in any video. In some implementations, the mobile and desktop consumer destination displays a list of video items that were noted, particular actresses or actors linked to one or more items, as well as similar items related to the one or more items. Recommendations or other items that users may find interesting will be determined based on an algorithm found in monetization engine.

According to various implementations, pre-recorded or live video 1065 may be included. The pre-recorded or live video may be provided by a provider of the tagging system, such as Purch, and may enable the tagging of pre-recorded video, including user generated video, DVD, BD, downloadable or streaming video, DVR, pre-recorded television shows, commercial advertisements, and movies. In various implementations, live television may also be tagged on demand. This may be accomplished through a method of growing an ROI around a user clicked object, and comparing that ROI to a database of tagged objects. If no object is found, then the object will be manually tagged. A repository of the tagged source videos may be kept.

In some implementations, a plurality of video display devices 1070 may be included. The plurality of video display devices may be one or more of various types of devices that can display video, including but not limited to: television screens; projectors; computer monitors; tablet devices; and Smartphones. For all displays that are already connected to the internet, various systems and methods disclosed herein enable the user watching a video to click on, tap, or otherwise select an object in a video stream and have the information about that object, including but not limited to the object name, description, and a list of vendors selling the object, to be displayed on the video display device as an overlay on the object, or within a bar adjacent to the video being displayed. Additionally, various advertisements can be overlaid on the video or adjacent to the video. These advertisements are generated by the monetization engine.

In various implementations, Purch Boxes or other Internet connected devices 1075 may be included. The Purch Boxes or other Internet connected devices may be used in conjunction with displays that are not natively connected to the internet, or for those video sources that are played through an internet connected device (e.g., a standard television signal, or standalone DVD, or normal television screen). An Internet connected device, such as a Purch Box, may take a video input, analyze the signal to determine which video is being displayed, and then allow the user to select, click on and otherwise interact with the video on the screen. Alternatively, through the various APIs, software may be installed on third party boxes to interact with the disclosed object database and monetization engine.

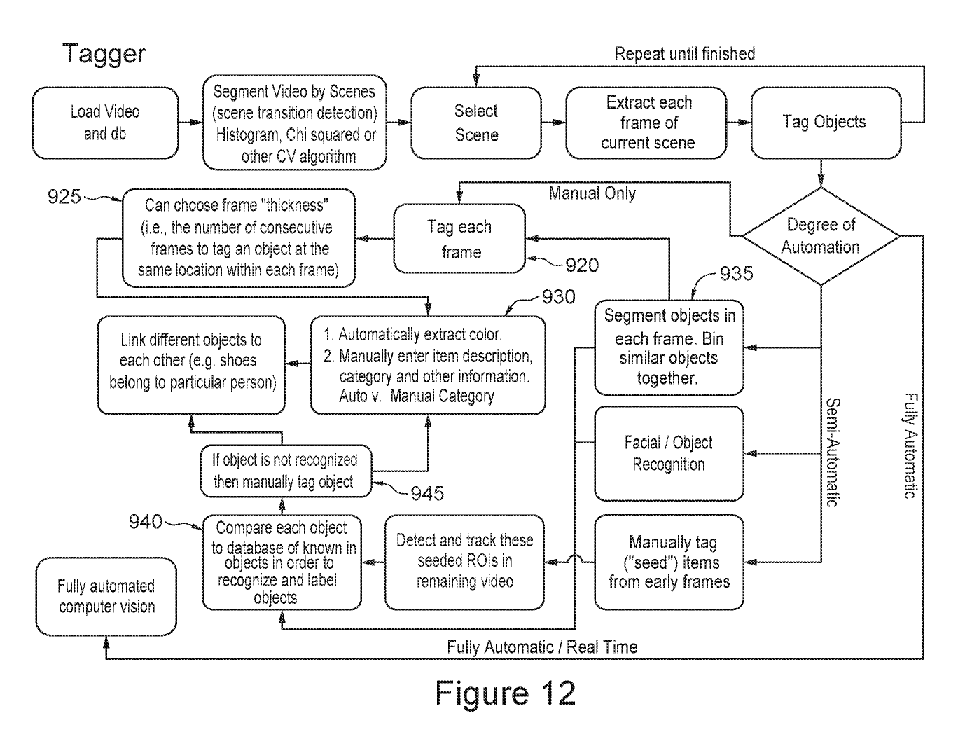

FIG. 12 shows another specific implementation of a flow for a tagger module. The flow is similar to the flow shown in FIG. 6 and described above. In this specific implementation, tagging each frame 920 can include a step 925 for choosing frame “thickness.” “Thickness” refers to the number of consecutive frames to tag an object at the same location within each frame. A step 930 includes automatically extracting color. A step 935 includes manually entering item description, category, and other information. There can be option to select automatic or manual category input.

Segmenting objects in each frame (step 935) can include comparing 940 each object to a database of known objects in order to recognize and label objects. Objects not recognized can be manually tagged 945.

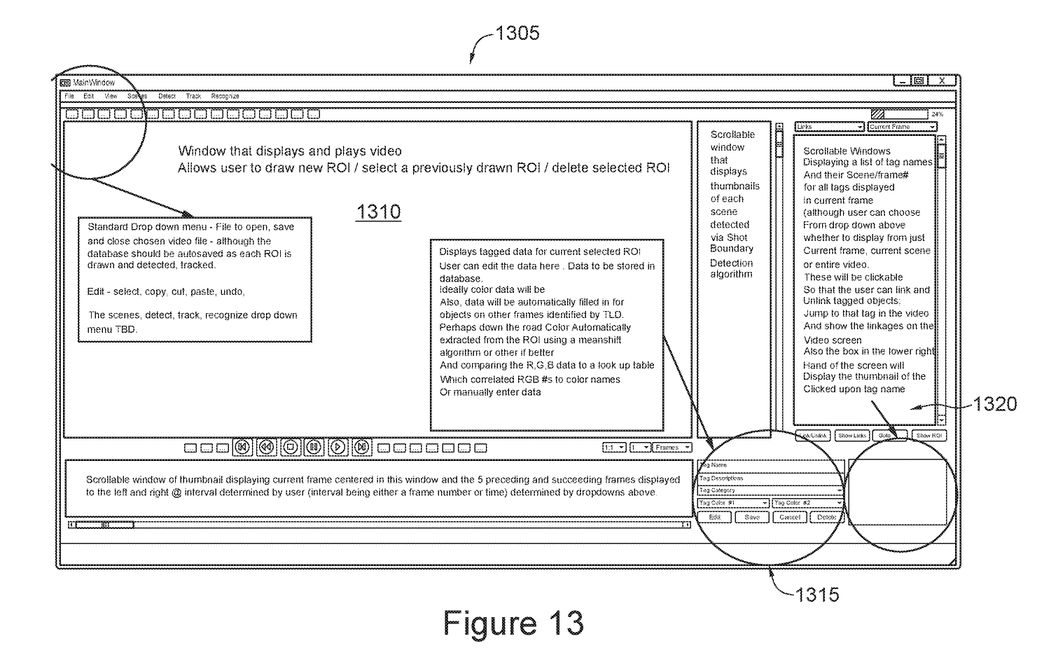

Furthermore, with regards to FIGS. 13-16, various implementations of a tagger application are described. In various implementations, the tagger application supports various features for a user input device, such as a mouse. For example, a left button may be used to click to select and click and hold to draw an ROI. A different button, such as a right button may be used to: access menu of options; link; unlink; and toggle all ROI on/off. Other buttons, such as a wheel, may be used to scroll forward or backward by the number of frames selected.

FIG. 13 shows a graphical user interface (GUI) of a main window 1305 of a tagging tool. The interface includes a first window region 1310 that displays and plays video, allows the user to draw a new region of interest, select a previously drawn ROI, and delete a selected ROI. There can be a second window region 1315 that includes controls and options for entering a tag name to be associated with the object in the ROI. There can be a third window region 1320 that includes a scrollable window for displaying a list of tag names and corresponding scene/frame numbers for all tags displayed in the current frame.

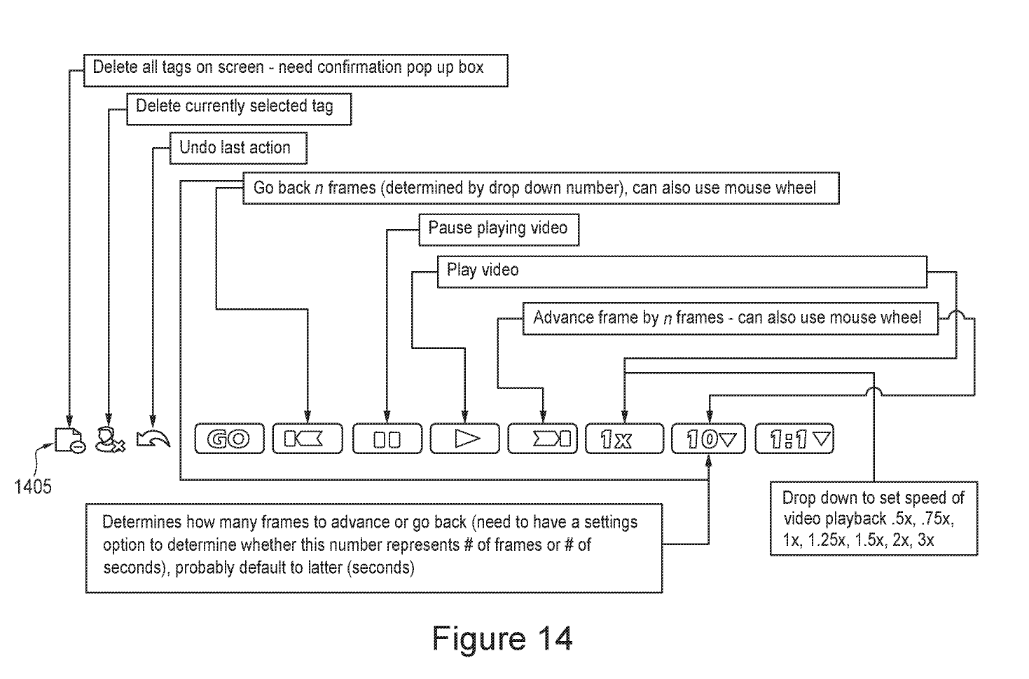

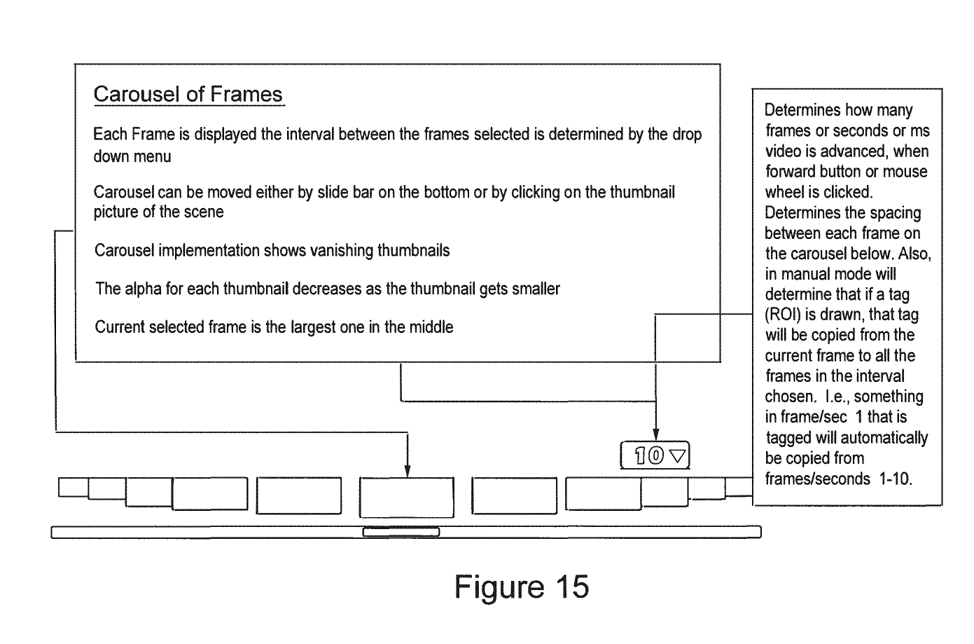

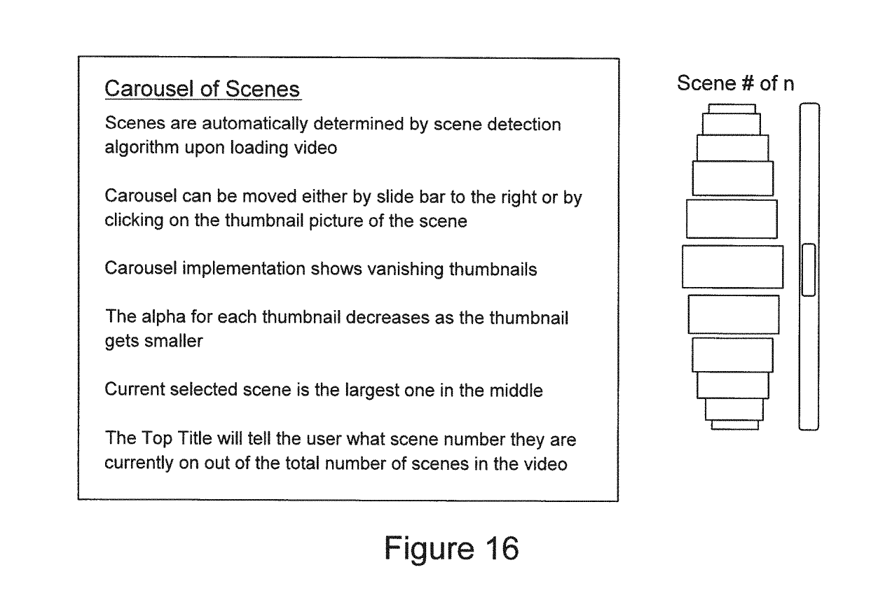

FIG. 14 shows a tool bar 1405 of the tagging tool. The tool bar includes controls for deleting a tag, undoing an action, and playing video. FIG. 15 shows a block diagram of a carousel interface for frames. FIG. 16 shows a block diagram of a carousel interface for scenes.

In various implementations, the tagger may interact with or be communicatively coupled to one or more databases. For example, the tagger may be coupled to the video repository database, as described with reference to FIG. 10. Moreover, the tagger may interact with a database of tags. In some implementations, the database of tags may store: a name of a video; a series number; an episode name; an episode number; a tag name; a tag category; tag links (what other tags is this tagged linked to); tag colors; tag SKU; a time stamp of a tag (or frame number of a tag); a location and size of a tag; and a thumbnail of a tag. In some implementations the tag database does not store a thumbnail because thumbnails may be created dynamically on the fly.

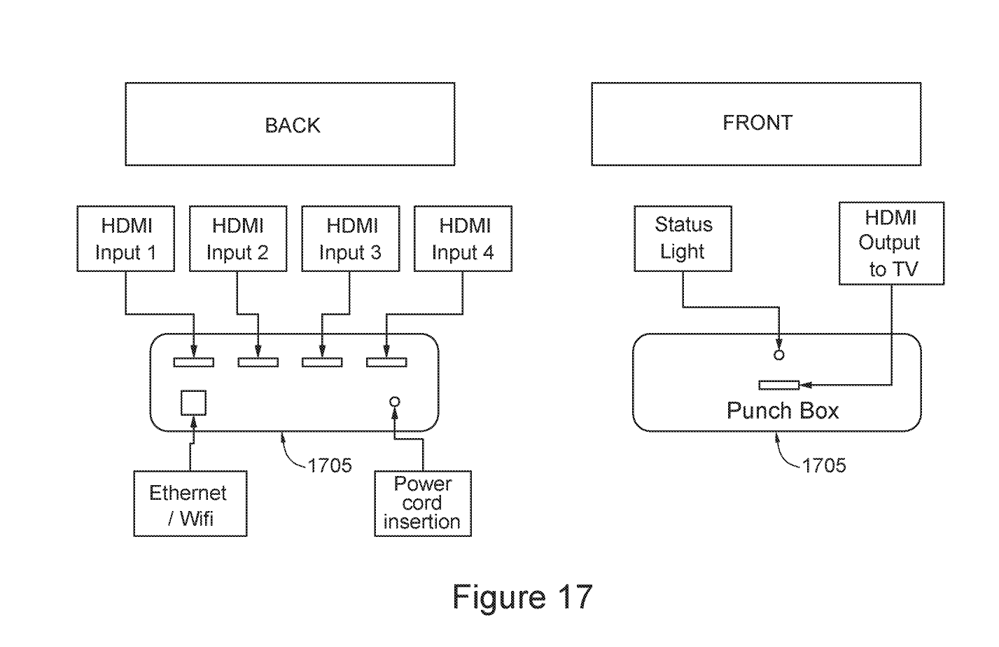

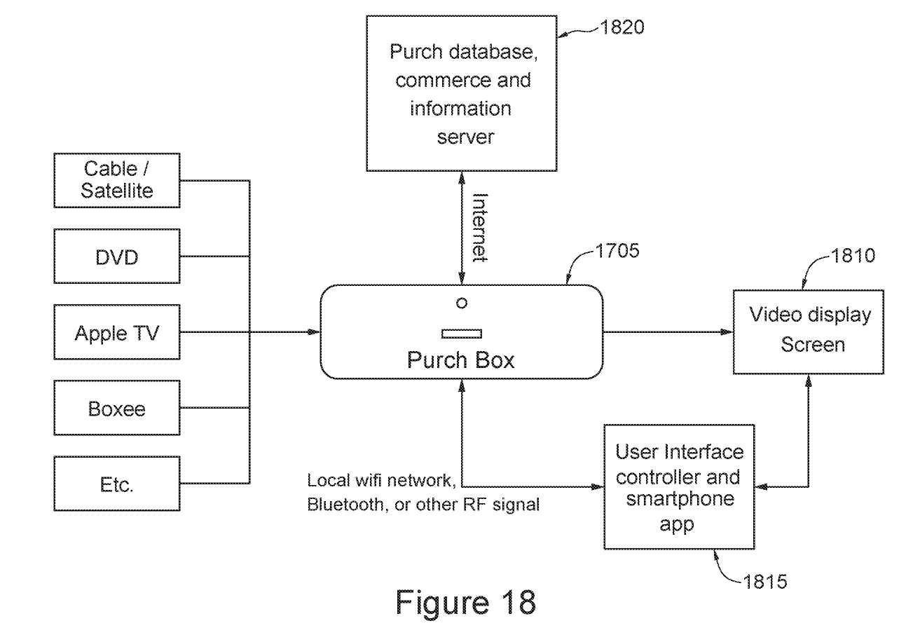

Moreover, with regards to FIGS. 17 and 18, various implementations of a consumer device 1705 are described. In various implementations, a consumer device may include a video display device screen 1810. The video display screen may display a plurality of objects per frame of each video. Each object is tagged and corresponds to an entry in a corresponding database. Objects that are not tagged can be compared to a database of known objects for recognition. In some implementations, a user may select each object through a user interface device 1815. The user interface device may be, for example, a touch, mouse, stylus, body motion, etc.

When the user selects an object, the information about the object stored within the video object database and monetization engine or internet 1820 is displayed either as an overlay on the video or in a separate window or bar adjacent to the video image. This information includes but is not limited to Wikipedia entries, name of the object, color of the object, a link or uniform resource locator (URL) to an ecommerce site or other site where that object may be purchased or other information displayed, a list of similar objects which may be purchased, advertisements related to the object selected, phone number of store where object can be bought, placement of the object in a shopping cart or list of objects one likes or is otherwise interested in, and the ability to share the object (i.e., the name of the video where the object was found, what the object was, etc.) via email, Twitter, Facebook or other social networking sites or technologies.

Additionally, various advertisements can be overlaid either on the video or in separate windows or bars adjacent to the video image based on a proprietary methodology which includes, but is not limited to: a theme of video; a sentiment of particular scene; an object's visibility in frame; a location of an object in a frame; the area the particular objects take up in the frame; a percentage of time a particular object is in a scene/video; linkage of objects to actors, people or other objects; popularity of one or more actors; perception of character's role in particular video; a color of an object; real life valuation of an object; keyword bidding; a consumer demographic; past purchasing and click behavior; friends' past behavior; and a frequency an object appears in a video or other videos.

In a specific implementation, a method of tagging objects in a video includes identifying, at a server, a plurality of objects in the video, linking, at the server, the plurality of objects to online e-commerce sites for immediate purchase, and linking, at the server, the plurality of objects to advertisements based on the nature of the plurality of objects.

The method may include presenting to a user a graphical user interface including a first window region, and a second window region, displaying in the first window region a frame of the video, permitting the user to draw a region of interest within the frame of the video, the region of interest defining a first object in the video to be tagged, and displaying in the second window region an input box for the user to input a tag to be associated with the first object.

The method may include providing the video to a consumer user, the video including a first object that has been linked to at least one of an online e-commerce site that sells the first object or an advertisement based on the nature of the first object, receiving from the consumer user a selection of the first object, and in response to the selection, providing to the consumer user at least one of a link to the online e-commerce site that sells the first object or the advertisement. At least one of the link or advertisement may be overlaid on the video. At least one of the link or advertisement may be in a window adjacent to a window displaying the video.

The method may include storing a listing of the plurality of objects identified in the video, the listing including a plurality of attributes associated with each object, wherein a first attribute associated with an object identifies the object as an article of clothing, and a second attribute associated with the object identifies a person from the video who wore the article of clothing.

The step of identifying, at a server, a plurality of objects in the video may include receiving from a user an identification of a brand to be associated with a first object, storing the first object and information identifying the brand associated with the first object in a database of pre-identified objects, receiving a new video including new objects to be tagged, comparing a first new object with objects stored in the database of pre-identified objects, determining that the first new object is similar to the first object, and automatically associating the first new object with the brand.

In another specific implementation, a system includes one or more servers including one or more processors configured to: receive a video input, analyze the video input, recognize a video associated with the video input, look up the video in a database of tagged videos, and output as an overlay or separate window to a video display device information about an item tagged in the video. The information may be external to the system. The information may be accessible over a network.

The one or more processors may be configured to: display a frame of a recording of a performance involving a plurality of items captured in the recording, receive an identification of a first item of the plurality of items, associate first information to the first item, and track the first item through the recording to associate the same first information to the first item when the first item appears in another frame of the recording.

In a specific implementation, the video includes a recording of a performance and the system includes a second database to store a plurality of attributes associated with the item tagged in the video, wherein a first attribute includes a description of the item, and a second attribute includes a title of the recording.

In another specific implementation, a method includes displaying on an electronic screen of a client device an interactive version of a video, wherein the video includes a recording of a plurality of objects, and at least a subset of the plurality of objects in the interactive version of the video is linked to information external to the video, while the interactive version of the video is playing on the electronic screen, receiving a selection of an object shown in the interactive version of the video, and in response to the selection, displaying on the electronic screen information linked to the selected object.

In a specific implementation, the step of displaying on the electronic screen information linked to the selected object comprises: displaying the information in a first window of the electronic screen while the interactive version of the video is displayed in a second window of the electronic screen.

In another specific implementation, the step of displaying on the electronic screen information linked to the selected object comprises: displaying the information in a first window of the electronic screen while the interactive version of the video is paused in a second window of the electronic screen.

In another specific implementation, the step of displaying on the electronic screen information linked to the selected object comprises: displaying the information in a first window of the electronic screen while the interactive version of the video continues to play in a second window of the electronic screen.

In another specific implementation, the step of displaying on the electronic screen information linked to the selected object comprises: displaying the information and the interactive version of the video in a window of the electronic screen, wherein the information is overlaid over the interactive version of the video. The information may include a link to a website that sells the selected object.

In a specific implementation, the method further includes highlighting in the interactive version of the video each object of the at least a subset of the plurality of objects to indicate that the object is linked to information external to the video.

In another specific implementation, the method further includes providing a user control to toggle between first and second playing modes of the interactive version of the video, wherein in the first playing mode each object of the at least a subset of the plurality of objects are highlighted to indicate that the object is linked to information external to the video, and in the second playing mode each object is not highlighted.

In another specific implementation, a method includes obtaining a recording of a performance involving a plurality of objects, generating an interactive version of the recording by linking objects captured in the recording to information accessible over a network, providing the interactive version of the recording to a client device, receiving from the client device a selection of an object captured in the recording, and providing, over the network, information linked to the object.

The step of generating an interactive version of the recording may include displaying a frame of the recording, the frame including the object involved in the performance and captured in the recording, associating the information to the object, and tracking the object through the recording to associate the same information to the object when the object appears in another frame of the recording. The performance may be recorded by a camera.

Aspects of the system have been described in connection with desktop or web implementations. It should be appreciated, however, that the system is not necessarily limited to desktop implementations. That is, aspects of the system can applied or adapted for use in many different types of computer platforms including mobile, tablets, laptops, phone, smart watches, and so forth.

In an embodiment, a system and method include manually placing an actual tag on actual items in a scene prior to the scene being acquired by a video camera system. The tagged items are linked to descriptions of those items residing in a database. The database associates the item with its unique tag, its description, a representative image or images, the location in 2 Dimensional or 3 Dimensional space of where the item is located in each from of the video, and the timestamp or designation of which frame or frames the item or items are visualized within the video.

In an embodiment, a video camera system is a device or several devices used for the electronic acquisition, broadcasting streaming or otherwise displaying of motion picture/images. Video cameras acquire/capture various scenes. Such scenes, whether representing live action or scripted or unscripted video productions are generally thought of as the action in a single location and/or continuous in time. Each scene is comprised of multiple subunits designated as frames. Each frame is one of the many still images which compose the complete moving picture. Various scenes are often acquired, edited and stored for future broadcast or broadcast live in real or near real time.

In an embodiment, an object may be physically tagged with a unique tag before the scene is acquired. The tag may be linked to a description of the actual item prior to or after the video acquisition. When the video is being acquired a computing device in the cloud, or local to the video acquisition may use various machine learning, artificial intelligence and/or computer vision algorithms to recognize the unique tags placed on the objects and track their location within each acquired frame/scene/video. The original video stream may be combined with an object tracking data stream and a data stream linking the tracked object to relevant information to create a video with which a user may interact.

In an embodiment, viewers of the video have the ability to interact with the tagged objects in the video by clicking, touching, pointing or otherwise selecting the item on the display device.

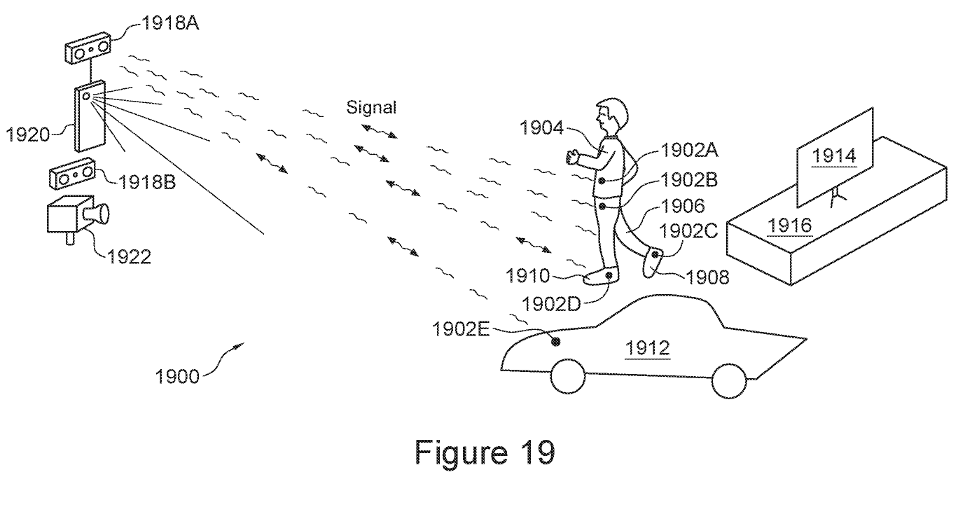

FIG. 19 shows aspects of a number of embodiments of a system 1900 for tagging items in a video and creating interactive links in the video to the tagged items. In the embodiment of FIG. 19, physical tags 1902A . . . 1902E are placed on various items in a scene. The items may include a shirt 1904, pants 1906, shoes 1908, 1910, and a car 1912. Other items in the scene may not be tagged, such as a television 1914 or television stand 1916.

In the embodiments, one or more localizer devices 1918A, 1918B receive a signal from each tag. The localizer devices 1918A, 1918B are in communication with a video camera 1920 or other device for acquiring digital video images 1922. In FIG. 19, signals between localizer 1918B and the tags are not shown for clarity, but are present like those between localizer 1918A and the tags.

In an embodiment, a localizer device emits a signal which elicits a response from each tag. Based on the time it takes the signal to return to the localizer devices the distance, direction, or both distance and direction of the tag with respect to the localizer devices may be determined.

In an embodiment, a localizer device may have more than one detection feature. That is, it may measure distance by one or more of: time of flight, relative signal strength, round trip time of signal etc. And it may measure incident angle either by one or more of: mechanical means (such as by a rotating detector), and by measuring time distance of arrival to an antennae array. Thus, the need for more than one localizer device can be obviated, e.g., by radar, which is a single device. In an embodiment, a single localizer device may be sufficient.

In an embodiment where the localizer device is limited to detecting solely distance to an object, more than one device is needed to localize the object. Similarly, if the localizer device is limited to measuring the signal's angle of arrival, then more than one device is needed.

In an embodiment, a localizer device may emit a signal and wait for a return signal, either reflected from, or emitted by the tag. Based on time of flight or relative signal strength intensity the distance can be determined. In an embodiment, such a localizer device may be placed on a rotating platform, and the signal detector may have a narrow field of view, such that signal will only be detected if facing the emitting source. Thus, angle and distance can be measured from a single such localizer device. In an embodiment, angle and distance can be measured from a single localizer device without mechanical moving parts, e.g., by electronically steering the localizer signal and determining relative signal strength to an array of antennae (or time distance of arrival to different elements of the array)

In an embodiment, the use of more than one localizer device may improve resolution and improve tracking and data redundancy. That is, additional localizer devices may be used to increase the spatial resolution of the determined positions of the tags. In an embodiment, a localizer device may be placed adjacent to the video acquisition device to determine the position of the tags relative to the video acquisition device. In an embodiment, a localizer device's location relative to the video acquisition device may be determined and the position of the tags relative to the video acquisition device determine by accounting for the relative difference in positions between the video acquisition device and the localizer device.

Embodiments may use one or more of three types of localizer devices. In a first type, a localizer device has components that can measure: 1. angle of arrival—mechanical or electronic means to discriminate angle as discussed above; and 2. distance. In a second type, a localizer device has components that can only measure angle. In a third type, a localizer device has components that can only measure distance.

In embodiments using localizer devices employing radio wave detection, to determine angle, the device may be equipped with, e.g., a directional antenna, an array of fixed antennae, a phase array, or a mechanical means to determine angle.

In embodiments of localizer device employing detection of light, there are multiple embodiments for detecting angle. One embodiment includes a scanning type of system, where the light beam is steered in a specific direction, either mechanically, electrically, or optically, or a combination thereof, and the detector waiting for the reflected signal only collects light from the specific direction the sensor faces. In this regard there is a directionality feature as well as distance features with a single detector. However, in other embodiments employing light, time difference of flight or other methods used for radio waves may be used based on the wave-particle duality of light. For example, distance to a lightbulb may be determined by an array of sensors measuring the intensity of emitted light.

In an embodiment, the type of tag placed on an item may receive a signal from a localizer device and in response emit a signal with a unique identifier. In an embodiment, the type of tag placed on an item may continually emit a signal with a unique identifier. In an embodiment, the type of tag placed on an item may reflect a signal back to a localizer device without the tag emitting its own signal. The reflection may be polarized or otherwise alter the reflected frequency or wavelength of the incident signal and thereby create a unique reflected identifying signal.

In an embodiment, a localization device determines an object's location by using the known techniques of triangulation, trilateration, or multilateration, or aspects of these. These techniques depend on the time a signal (e.g., radio wave, light wave) takes to travel the direct path between the object and the receiver.

Triangulation allows an observer to calculate their position by measuring two directions towards two reference points. Since the positions of the reference points are known, it is hence possible to construct a triangle where one of the sides and two of the angles are known, with the observer at the third point. This information is enough to define the triangle completely and hence deduce the position of the observer.

Using triangulation with transmitters requires the angle of incidence (angle of arrival, or AoA) of a signal to be measured. For radio waves, this can be done using several antennas placed side by side (an array of antennas, for example, FIG. 2) and to measure the phase difference between the signals received by the antennas. For light waves, photodetectors may be used in a manner similar to antennas.

Trilateration requires the distance between the receiver and transmitter to be measured. This can be done using a Received Signal Strength Indicator (RSSI), or else from the time of arrival (ToA)—or time of flight (ToF)—of the signal, provided that the receiver and transmitter are synchronized—for example, by means of a common timebase, as in GPS. The length of the time to arrival at receiver P of the signals broadcast by three transmitters A, B, and C forms a measurement of the distances between the transmitters A, B, and C, and the receiver.

Multilateration uses a single receiver listening to the signals (pulses, for example) from two synchronized transmitters. With two such transmitters, it is possible to measure the difference between the arrival times (time difference of arrival, or TDoA) of the two signals at the receiver. Then the principle is similar to trilateration.

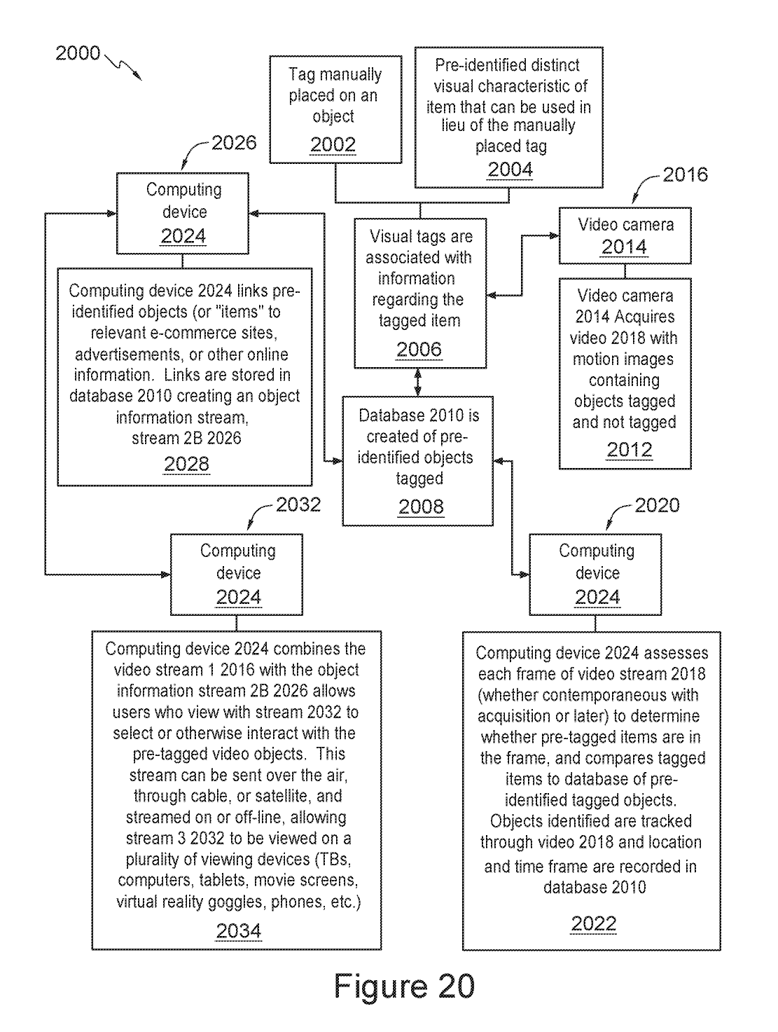

FIG. 20 shows a block diagram of an embodiment of a method 2000 for tagging items in a video. In step 2002, tags are manually placed on selected objects. In step 2004, one or more distinct visual characteristics of item are identified that may be used in lieu of a physical tag.

In step 2006, each visual tag is associated with information regarding the tagged item, such that in step 2006 there is an association between a tagged item and identifying information. In step 2008, a database 2010 is created with the tagged items and their associated identifying information.

In a stream 1 2016 of the method, in step 2012, a video camera 2014 acquires a first video 2018 with images of the tagged objects along with other non-tagged objects. Stream 1 2016 may be considered the native video feed.

In a stream 2A 2020 of the method, in step 2022, a computing device 2024 executing a software tagging component accesses each frame of acquired video 2018. The access may be contemporaneous with the video acquisition or afterwards. During the access of each frame, the tagging component determines whether a tagged item is in the frame. When a tagged item is discovered, the tagging software compares each discovered tagged item to the items in database 2010. Each discovered tagged item is tracked through the video 2018 and its locations and associated times are recorded in database 2010, creating stream 2A 2020 for the particular video. Stream 2A 2020 may be considered a metadata stream of tagged items and their associated information.

In step 2028, computing device 2024, executing a software linking component, links the pre-identified, tagged objects in database 2010 to relevant information such as e-commerce advertisements and other on-line information. These links are stored in database 2010, associated with the related tagged item(s), the related video, and the associated location and time within the video. For acquired video 2018, the pre-identified tagged items and their associated links, locations, and times are used to create an object information stream, stream 2B 2026 for the particular video. Stream 2B 2026 may also be considered a metadata stream of tagged items and their associated information.

In step 2034, computing device 2024 executing a combining software component, combines video stream 2016 with object information stream, stream 2B 2026 to create a tagged and linked video, stream 3 2032. Stream 3 2032 allows viewers to select or otherwise interact with the tagged items in the video. Tagged and linked video (stream 3 2032) may be broadcast over traditional systems, e.g., over the air, cable, and satellite, and streamed on or off-line, allowing stream 3 2032 to be viewed on any of the variety of viewing devices (e.g., television, computers, tablets, movie screens, virtual reality goggles, smart phones, etc.). The interactive features, i.e., the tags associated with items in video 2032, may be accessed when video 2032 is viewed on systems that support such interaction, e.g., computers, tablets, smart phones, virtual reality goggles, with the connectivity necessary to follow the embedded links. Stream 3 2032 may be considered the clickable/selectable item stream of the combined streams 1 2016 and stream 2B 2026.

In an embodiment, a video acquisition device may acquire moving or still images, or both moving and still images.

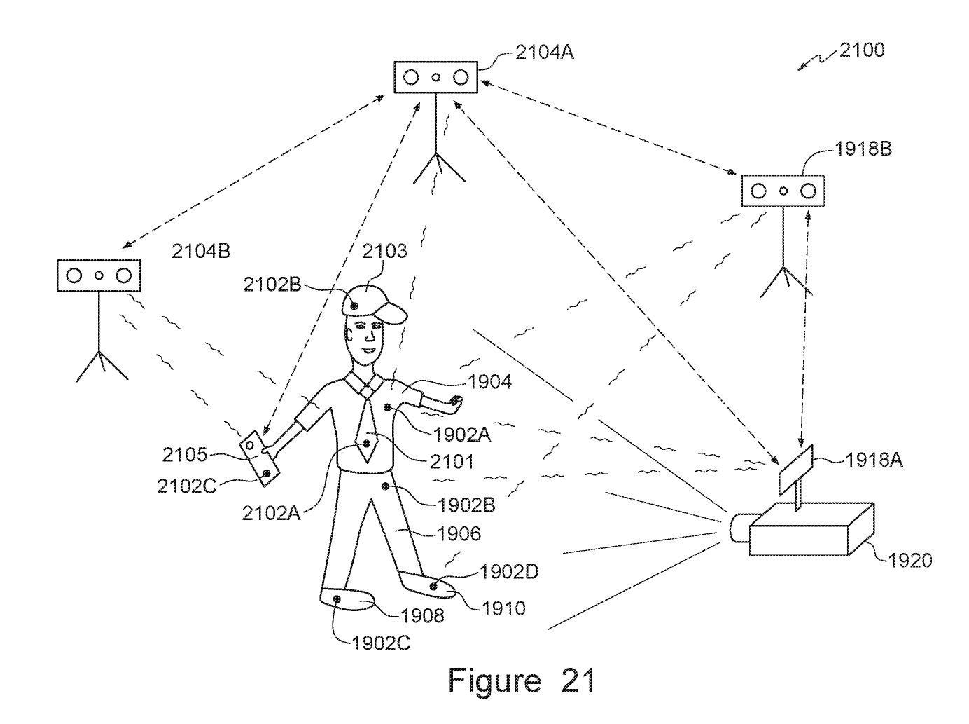

FIG. 21 shows aspects of an embodiment 2100 of system 1900 for tagging items in a video. Embodiment 2100 illustrates that more than one localizer device may be used simultaneously. For example, in embodiment 2100, localizer device 1918A is associated with the location of video camera 1920. Localizer devices 1918B, 2104A, and 2104B are positioned about the periphery of the subject who is wearing the tagged items: hat 2103, shirt 1904, phone 2105, pants 1906, tie 2101 and shoes 1908, 1910. Each tagged item is shown to have an associated tag: 1902A, 1902B, 1902C, 1902D, 2102A, 2102B, 2102C. Each localizer device determines the position (distance and direction) of each item relative to that localizer device. Each localizer device is also equipped with a tag, similar to the tag on each item, so that each localizer device may determine the positions of the other localizer devices. With data of the relative positions of the localizer devices, and data of the relative positions of the tagged objects with respect to each localizer device, the precision and accuracy of the object information in object information stream 2030 may be improved.

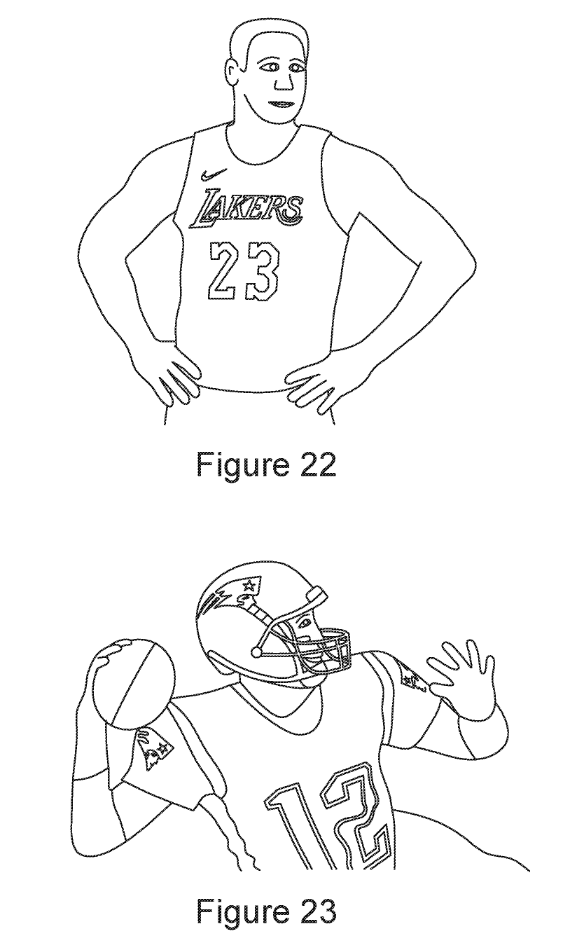

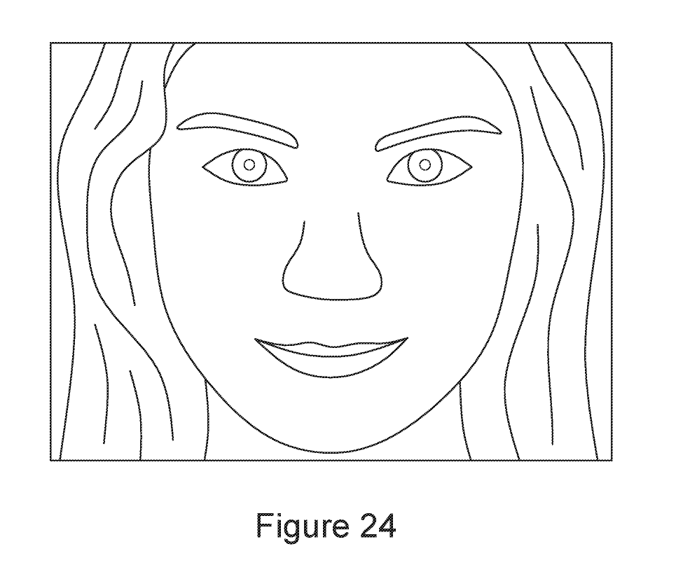

FIG. 22 and FIG. 23 show examples of pre-identified objects that may act as a physical tag in an embodiment. In FIG. 22 and FIG. 23, unique features of the figures, or the apparel, or the equipment, may be identified and tracked in lieu of an added physical tag. These unique visual features may be considered visual tags. For example, in FIG. 22, the jersey number, the tattoo, the team name, and some combination of number, tattoo, and team name, may each be “the” tracked feature. Similarly, in FIG. 23, the helmet, the football, the jersey number, the helmet logo, the sleeve logo, and the team name, and some combination of these, may each be “the” tracked feature.

In an embodiment, pre-identified items can contain unique visual information that can be used in lieu of placing a physical tag on the object. For example a number on article of clothing, the logo on the article of clothing, the color of the article of clothing, name of the clothing. In such an embodiment, the pre-identified object can act as the physical tag (e.g., the logo, number, etc.)

Such tags based on visual information may be photographed prior to the video acquisition and stored in the database 2010 for comparison to the acquired video, such that by using various computer vision and machine language and AI algorithms the object/tag can be identified and tracked temporally and spatially through each frame of the video.

Facial features may be the visual information upon with a tag is based. FIG. 24 shows an example of facial features that may act as a physical tag in an embodiment.

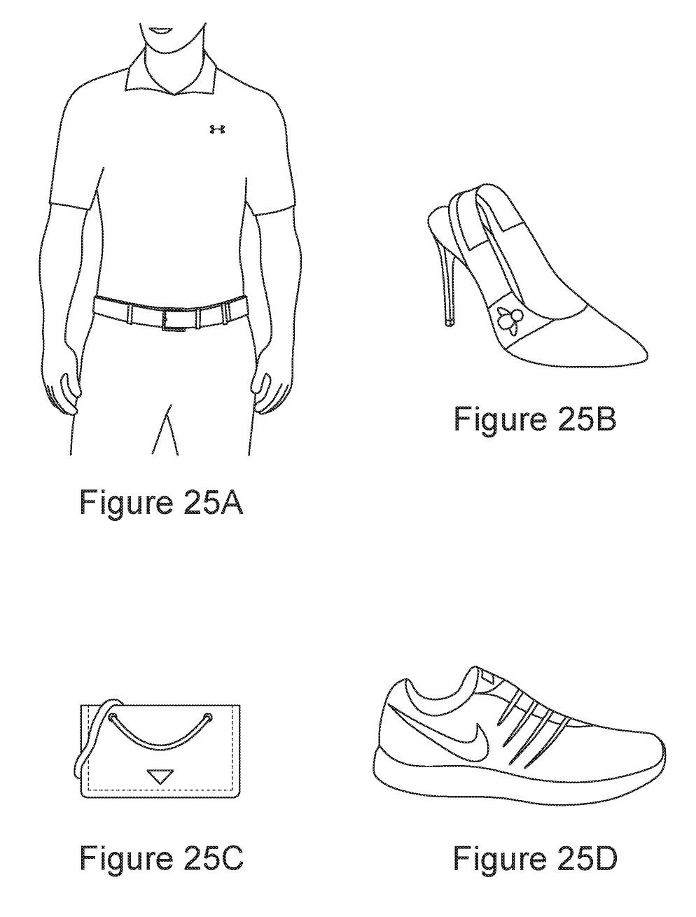

Clothing brand logos, unique design elements, shapes, colors, etc. may be used as a pre-identified tag. FIG. 25 shows additional examples of items with features that may be used as a pre-identified tag.

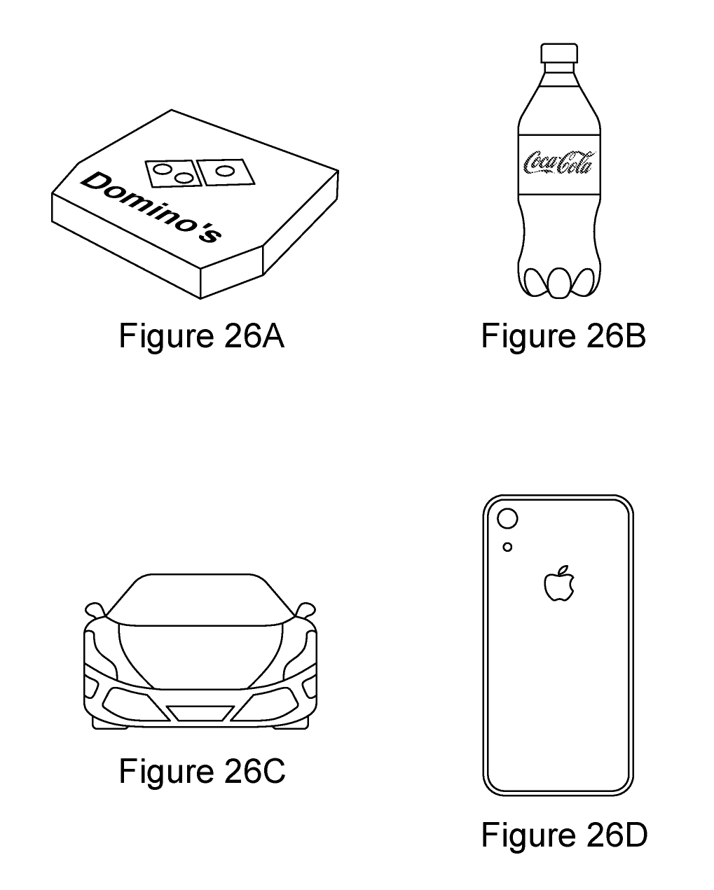

The pre-identified features are not limited to features on items of apparel. FIG. 26 shows additional examples of objects with features that may be used as a pre-identified tag.

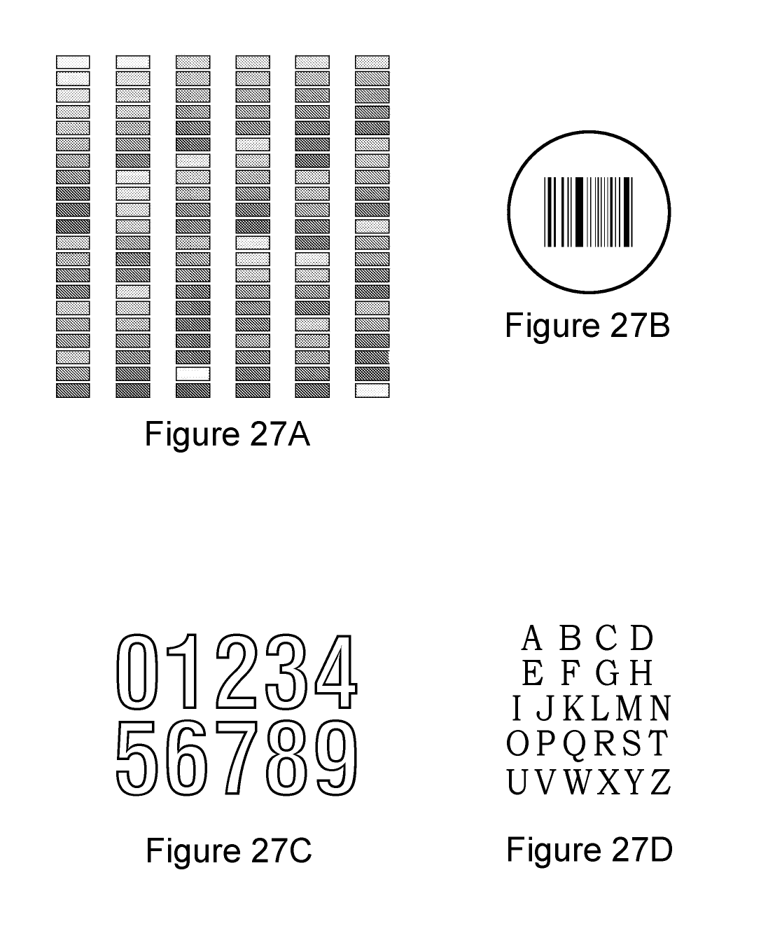

In an embodiment, an object may be physically tagged by placing a swatch of a unique color to be tracked, or a unique combination of letters, numbers or other identifying marks can be placed on an object to track them during the video acquisition. FIG. 27 shows additional examples of tags that may be applied to object and used as a pre-identified tag during video acquisition.

In an embodiment, an object may be tagged by placing a swatch of a unique color to be tracked, or a unique combination of letters, numbers or other identifying marks (such as, e.g., those shown in FIG. 27) on the object after the video acquisition.

Visual Tags

In embodiments, a physical tag, e.g., tags 1902A . . . 1902E may be, e.g., a unique QR code, bar code, color patch, logo, or other unique identifying object placed upon various real-life objects prior to video acquisition.

In embodiments, a visually distinct object may be pre-identified and used in lieu of a physically placed tag (for example, the jersey number on a basketball player's shirt, the logo on a helmet or, pizza box, article of clothing, etc.)

The pre-identified objects and physically tagged objects may be stored in a database and linked to a description of the object particular object. The description may take the form of all or some of the following:

1) A text description of the item that includes but is not limited to the particular item SKU code, the name of the item, the color of the item, the item brand, the name of the person wearing the item, the general category of item (e.g., clothing, kitchen appliances, electronics, automobile, tree, animal, etc.), and the particular product or similar products represented by the item.

2) A mathematical or other computer generated algorithmic description of the item, that may include the: RGB or other color indicator of the object, other mathematically/algorithmically generated object classifiers, feature maps, or descriptors.

3) A digital image or series of images of the object (such as a JPEG, TIFF, GIF, RAW or other digital representation of the object) represented by the tag or pre-identified item.

In embodiments, the tags in the database may then be linked in the database to online content such as e-commerce sites that may sell the particular object and/or similar and/or related objects or to various advertisements that may feature the particular object and/or similar and/or related objects.

Each tag or uniquely identified object may be recognized in the video through various machine language, artificial intelligence and/or computer vision algorithms. Upon recognition, one or more of the location of the tag, the underlying object to which the tag is attached, and the location of the pre-identified object will be tracked through each frame of the video. Some or all of the following will be stored in the database associated with the tag (or pre-identified visual object serving as a tag): the location in the frame of the tag and the underlying object, the location of any pre-identified object in each frame, the coordinates of a bounding box around the tag as well as the actual object which was tagged, the timestamp within the video in which the object appears, the frame number of which it appears, all computer generated feature descriptions of the tagged object, associated links, associated ads, and any other description of the object and/or tag.

In an embodiment, the linking of information, etc., to each tag or pre-identified unique object “prior to” acquisition may be performed as follows.

A list of tagged items and their descriptions is connected to a pre-existing database of exact items, similar or like items, or other related (but not exact or similar) items, that have already been previously described. These previously-described items will have pre-populated links to related ads, ecommerce sites, or other information that will be already available in an existing online or offline database. The newly-added tagged items are associated with the information in the item that already exists in the database (i.e., the same exact item, similar or like items, or other related items).

In an embodiment, during video acquisition, the temporal and spatial location of each object tagged or each pre-identified object takes place simultaneously with the video acquisition using various computer vision/machine learning/AI algorithms or alternatively manually tracked. This location information is added to the database and associated with the tagged object.

In an embodiment, linking each tag or pre-identified object “after acquisition” of the video may be performed as follows.

As described above, the tags or pre-identified objects are identified prior to video acquisition. A list of these items and associated descriptions are accessible in a database prior to acquisition. The linking of this data to the ecommerce site links, advertisement links of the particular object or similar or related objects takes place after the video acquisition occurs. In other words, the list of items to be tagged and actually tagged or pre-identified occurs prior to video acquisition. The video is acquired, the temporal and spatial location of each tag/pre-identified object is stored simultaneous to the video acquisition. The list of items tagged or pre-identified are then linked to one or more separate database(s) of exact items available for sale, related items available for sale, links to ecommerce sites or other advertisements, and/or online information after the video acquisition takes place.

In an embodiment, the tracking of the objects may take place after the video is acquired and the information associated with the object in the database after video acquisition.

In an embodiment, once an object is tagged or pre-identified various computer vision/machine learning/AI algorithms may be used to track the set of algorithmically generated descriptors of the tag through each frame, such that its location on the frame may be determined. Additionally, through various segmentation or other computer vision algorithms a bounding box surrounding the underlying object demarcated by the tag or pre-identified object can be created and tracked and its temporal and spatial location stored. This can be done simultaneously with or after video acquisition.

Visual Tag Method

In an embodiment of a method for tagging an item, in a first step an item (also an “object”) is identified prior to video acquisition.

In a second step a physical tag is placed on the object, or a unique feature to be tracked is identified and a digital image of the unique visual feature is used in lieu of adding a physical tag. These unique visual features are also considered visual tags for the remainder of this method.

In a third step, the information associated with the tagged item is stored in a database. The information may include: the physical tag, unique tag id, underlying item name/description, digital images of the tag and underlying object are stored in a database.

In a fourth step, the database is then used by computing device to track the tag and/or object. The database is “used” in the sense that the objects stored in the database are used as the reference against which each frame is checked to determine whether any of the objects in the database are in that frame. If an database object is, in fact, in a frame then the location of the object, the timestamp and frame number, etc., of the frame is stored in the database. This is the tracking information that is stored in the database. See above regarding specific implementations of tagging, including the text related to FIG. 9 and FIG. 10, for additional explanation. The temporal and spatial location of each tag and object is linked to the initial database. In an embodiment, tracking may occur contemporaneously with or after video acquisition.

In a fifth step, the items in the database are linked (either prior to, contemporaneously with, or after video acquisition) to the relevant ecommerce sites, advertisements and other online information in the database, as previously described above. For example, each object tagged within the video may have a corresponding advertisement that will be displayed either as an overlay on the video or along the gutter of the screen. Each advertisement may be linked to the website or other URL directed by the advertiser. Further explanation may be found above in the text following the discussion of FIGS. 17 and 18.

In this embodiment of the method, an original video stream is created, a second object data stream is created, and a third stream of both video and interactive content is derived from the combination of the tagging and tracking of objects and linking them to the appropriate links.

Emitter or Reflector Tags

In an embodiment, a first non-visual tag option includes an emitter tag with a transceiver device that detects a particular electromagnetic radiation frequency. In response to this detection it emits its own unique electromagnetic radiation. For example, such radiation may be similar to an RFID device.

In the embodiment, the signal emitted by the transceiver tag device is then detected by another transceiver device—a transceiver-equipped localizer device.

In an embodiment, the localizer device may be both the original source of the signal that caused the transceiver tag to emit its own signal as well as the detector of the signal emitted by the transceiver tag. The localizer device detects the signal emitted by the tag. One or more localizer devices may be used, spaced apart, to triangulate or trilaterate the location of the transceiver tag in 3D space.

Additionally, localizer devices may emit and detect signals from other localizer devices to determine the spatial distance between each of the detectors.

These localizer devices may be placed anywhere in the real 3D space that will be used for the video acquisition, including but not limited to movie or tv sets, indoor rooms, stadia, arenas, theaters, or even the outside in unenclosed spaces.

A localizer device or transceiver tag may be placed on the video camera or video cameras to help spatially map the 3D coordinates of the tagged object with reference to each video camera. The 3D space coordinates may be referenced relative to the camera or cameras taking the video but may also be translated to any coordinate system based on the location of a localizer or transceiver device.

Localizer devices may be placed anywhere within the 3D space where the video is being acquired. In an embodiment, the number of devices required is one, where the embodiment requires distance from the localizer device. In other embodiments, at least two localizer devices are required. Localizer devices may rely on techniques including: ranging techniques, angle of arrival techniques, triangulation, trilateration, and iterative/collaborative multilateration.

Regarding tags with transceiver devices. In an embodiment, the minimum number of localizer devices is one—for the use case where a tagged object is located solely with respect to the camera. Similarly, for the second and third tag options discussed below, a single localizer device may be used where a tagged object is located solely with respect to the video camera.

In an embodiment, the 3D position of tags in will be stored in reference to the video camera(s) acquiring the video.

In an embodiment, a 3D coordinate position of a tag may be mapped to a 2D frame image using one of the many mathematically/algorithmic methods for mapping a 3D coordinate to a 2D image.

In an embodiment, a second tag option includes using a tag that emits a unique signal. Such tags may be affixed to one or more objects. A corresponding signal detector device(s) that detects these unique signals is associated with the video camera or cameras. The signal detector localizes the angle (altitude and azimuth) of the signal emitted by the signal tag with respect to the signal detector. The signal may be any type of radiation in the electromagnetic spectrum. By cross referencing the angle from where the signal arose to the quadrant of the video image corresponding to that angle, objects can be detected and tracked through each frame. In the embodiment, and similar to the visually-based tags discussed above, a description of the item and can be linked before video acquisition, in real-time during acquisition, or after acquisition, to corresponding e-commerce, advertisement and other online data.

In an embodiment, a third tag option includes a tag in the form of a reflector that reflects electromagnetic radiation back to its source. In the embodiment, an emitter/receiver device sends a signal out and any object that has a reflector tag that is struck by the signal will reflect the signal back to the emitter/receiver device. Upon detecting the reflected signal, the emitter/receiver device measure the time difference between the emission of the signal and its return to the sensor, after being reflected by an object. From the measured delay, the distance from the emitter/receiver and the object may be determined. This information about the distance to the video camera can then be mapped to the visual image created by the video camera and used to track the object.

In the embodiment using one of the optional tags, and similar to the visually-based tags discussed above, a description of the item and can be linked before video acquisition, in real-time during acquisition, or after acquisition, to corresponding e-commerce, advertisement and other online data.

Additionally, in an embodiment, one or more of the systems with the different tag options may be combined and used to track the objects.

Additional Tag Method

In an embodiment of a method for tagging an item, in a first step an object is identified prior to video acquisition. In a second step, one of the first, second, or third non-visual optional tags are affixed to various objects of interest. In a third step, a localizer device is either embedded within or separately attached or placed near the video camera device. Additional localizer devices may be placed around the physical area where the video acquisition will occur. However, the localizer device technically does not have to be attached to or near the video camera device if the video camera device also has a tag to localize it with respect to the localizer. In a fourth step similar to the visual tag description above, each tag is stored in a database with its unique tag ID, a text description and name of the underlying object to which the tag is affixed, and a digital image of the underlying object.

Regarding the fourth step, for the case of the first optional tag—the transceiver type tag—the localizer device emits a signal that is detected by the transceiver tag. In response the transceiver detects the signal and emits its own unique signal. By localizing the direction from where this return signal arose and determining the length of time of each signal took, the location with respect to one or more localizer devices can be obtained. Using a reference point of view from the camera that is acquiring the video, the location of the tagged objects may be found in the video and tracked through each frame. It may be the case that more than one localizer device is required in addition to the main localizer device placed with camera to adequately determine the location of the tagged object. The tracking information is stored in the database.

Regarding the fourth step, for the case of the second optional tag—the emitter tag—the difference is that the tag continuously emits a signal. The emitter tag is not responding to a localizer signal. One or more localizer device may detect this signal. Where one localizer device is used, the distance and direction of the tag location may be determined. If there is more than one localizer the distance and direction may be more precisely determined. The tracking information is stored in the database.

Regarding the fourth step, for the case of the third optional tag—the reflector tag—the localizer device emits a signal that is reflected back to the localizer, using time of flight calculations the distance to the tag can be calculated. The tracking information is stored in the database.

In embodiments using one of the non-visual, optional tags, object tracking occurs simultaneous to video acquisition.

In a fifth step, the items in the database are linked (either prior to, contemporaneously with, or after video acquisition) to the relevant ecommerce sites, advertisements and other online information in the database, as previously described above.

In this embodiment of the method, an original video stream is created, a second object data stream is created, and a third stream of both video and interactive content is derived from the combination of the tagging and tracking of objects and linking them to the appropriate links.

Virtual Reality or Augmented Reality Tag

In an embodiment, a virtual object to be displayed in a virtual or augmented reality may be tagged by person on a computer system prior to the display of that virtual object in the display device. This tagged item may then be linked in a similar fashion to the various exact, similar or related item ecommerce sites, advertisements etc.

In the description above and throughout, numerous specific details are set forth in order to provide a thorough understanding of an embodiment of this disclosure. It will be evident, however, to one of ordinary skill in the art, that an embodiment may be practiced without these specific details. In other instances, well-known structures and devices are shown in block diagram form to facilitate explanation. The description of the preferred embodiments is not intended to limit the scope of the claims appended hereto. Further, in the methods disclosed herein, various steps are disclosed illustrating some of the functions of an embodiment. These steps are merely examples, and are not meant to be limiting in any way. Other steps and functions may be contemplated without departing from this disclosure or the scope of an embodiment.

1.-20. (canceled)

21. A method comprising:
associating, using a computing device, first information with a first tag, the first tag being physically applied to a first physical object before or after the first information is associated with the first tag;
storing, by the computing device, first tag identifying information and the associated first information in a database;
acquiring a digital video including video of the first tag on the first physical object;
determining, using the computing device, second information regarding a location of the first tag within the digital video;
associating, using the computing device, the second information with the first tag identifying information within the database; and
creating, using the computing device, an interactive video using the digital video, the first information, and the second information, such that when a user interacts with the first tag or the first physical object in the interactive video the user is provided with access to the first information.

22. The method of claim 21, further comprising:
creating, using the computing device, an object information stream by the associating, using the computing device, the second information with the first tag identifying information within the database,
wherein the creating, using the computing device, an interactive video using the digital video, the first information, and the second information, includes:
combining the digital video with the object information stream.

23. The method of claim 21, wherein the first information includes at least one of: an e-commerce site, on-line information, an advertisement, or internet-accessible information external to the video.

24. The method of claim 21, wherein the first tag on the first physical object includes one of:
a QR code, a bar code, a color patch, a logo, or an identifying object;
a first electronic device emitting a first signal;
a second electronic device emitting the first signal in response to receiving a second signal; and
a reflective device reflecting a third signal back to a transmitting device.

25. The method of claim 24, wherein determining, using the computing device, second information regarding a location of the first tag within the digital video includes:
receiving, by the computing device, the second information from a third electronic device, the third electronic device interpreting the first signal or the reflected third signal to provide the second information.

26. The method of claim 21, further comprising:
determining, using the computing device, fifth information regarding a location of the first physical object within the digital video; and
associating, using the computing device, the fifth information with the first tag identifying information within the database, wherein:
the creating, using the computing device, an interactive video using the digital video, the first information, and the second information, such that when a user interacts with the first tag or the first physical object in the interactive video the user is provided with access to the first information includes using the digital video, the first information, the second information, and the fifth information such that when a user interacts with the first tag or the first physical object in the interactive video the user is provided with access to the first information.

27. A non-transitory, computer-readable storage medium having stored thereon a plurality of instructions, which, when executed by a processor of a computing device, cause the computing device to:
determine first information regarding a location of a first tag within a digital video, wherein:
the first tag was physically applied to a first physical object before the video was acquired,
second information is associated with the first tag,
the second information and first tag identifying information are stored a database, and
the digital video includes video of the first tag and the physical object;
associate the first information with the first tag identifying information within the database; and
create an interactive video using the digital video, the first information, and the second information, such that when a user interacts with the first tag or the first physical object in the interactive video the user is provided with access to the second information.

28. The computer-readable storage medium of claim 27, the instructions further causing the computer device to:
create an object information stream by the associating the first information with the first tag identifying information within the database,
wherein the create an interactive video using the digital video, the first information, and the second information, includes:
combining the digital video with the object information stream.

29. The computer-readable storage medium of claim 27, wherein the second information includes at least one of: an e-commerce site, on-line information, an advertisement, or internet-accessible information external to the video.

30. The computer-readable storage medium of claim 27, wherein the first tag on the first physical object includes one of:
a QR code, a bar code, a color patch, a logo, or an identifying object;
a first electronic device emitting a first signal;
a second electronic device emitting the first signal in response to receiving a second signal; and
a reflective device reflecting a third signal back to a transmitting device.

31. The computer-readable storage medium of claim 30, wherein the determine first information regarding a location of the first tag within the digital video includes:
receive the first information from a third electronic device, the third electronic device interpreting the first signal or the reflected third signal to provide the first information.

32. The computer-readable storage medium of claim 27, the instructions further causing the computer device to:
determine fifth information regarding a location of the first physical object within the digital video; and
associate the fifth information with the first tag identifying information within the database, wherein:
the create an interactive video using the digital video, the first information, and the second information, such that when a user interacts with the first tag or the first physical object in the interactive video the user is provided with access to the second information includes using the digital video, the first information, the second information, and the fifth information such that when a user interacts with the first tag or the first physical object in the interactive video the user is provided with access to the second information.

33. A method comprising:
tagging a first physical object with a first tag by identifying as the first tag a visual characteristic of the first physical object;
associating, using a computing device, first information with the first tag;
storing, by the computing device, first tag identifying information and the associated first information in a database;
after the first tag identifying information and the associated first information are stored in a database, acquiring a digital video including the first physical object and the first tag;
determining, using the computing device, second information regarding a location of the first tag within the digital video;
associating, using the computing device, the second information with the first tag identifying information and first information within the database; and
creating, using the computing device, an interactive video using the digital video, the first information, and the second information, such that when a user interacts with the first tag or the first physical object in the interactive video the user is provided with access to the first information.

34. The method of claim 33, further comprising:
creating, using the computing device, an object information stream by associating the second information with the first tag identifying information within the database,
wherein the creating, using the computing device, an interactive video using the digital video, the first information, and the second information, includes:
combining the digital video with the object information stream.

35. The method of claim 33, wherein the first information includes at least one of: an e-commerce site, on-line information, an advertisement, or internet-accessible information external to the video.

36. The method of claim 33, wherein the visual characteristic includes at least one of:
a number, a logo, an icon, or a color.

37. The method of claim 33, wherein determining, using the computing device, second information regarding a location of the first tag within the digital video includes:
recognizing, by the computing device, the first tag within the digital video;
tracking, by the computing device, the first tag through the digital video, the tracking providing times that the first tag is in the digital video and providing locations associated the times.

38. The method of claim 33, further comprising:
determining, using the computing device, fifth information regarding a location of the first physical object within the digital video; and
associating, using the computing device, the fifth information with the first tag identifying information within the database, wherein:
the creating, using the computing device, an interactive video using the digital video, the first information, and the second information, such that when a user interacts with the first tag or the first physical object in the interactive video the user is provided with access to the first information includes using the digital video, the first information, the second information, and the fifth information such that when a user interacts with the first tag or the first physical object in the interactive video the user is provided with access to the first information.
